(19) United States
(12) Patent Application Publication
(10) Pub. No.: US 2026/0147745 A1
(43) Pub. Date: May 28, 2026

(54) APPARATUS AND METHOD FOR RESOLVING DATA DISCREPANCIES BETWEEN A FIRST DATA STRUCTURE AND A SECOND DATA STRUCTURE

(71) Applicant: Signet Health Corporation, North Richland Hills, TX (US)

(72) Inventors: Blake Browder, Dallas, TX (US); Joy Figarsky, Little Rock, AR (US)

(73) Assignee: Signet Health Corporation, North Richland Hills, TX (US)

(21) Appl. No.: 18/957,824

(22) Filed: Nov. 24, 2024

(51) Int. Cl. G06F 16/23

(52) U.S. Cl. CPC G06F 16/2365

(57) ABSTRACT

Apparatus and method for resolving data discrepancies between a first data structure and a second data structure are disclosed. The apparatus includes a memory communicatively connected to at least a processor, wherein the memory contains instructions configuring the at least a processor to access a first data structure, wherein the first data structure includes a plurality of first data fields representing primary data, access a second data structure, wherein the second data structure includes a plurality of second data fields representing secondary data, identify one or more discrepant data fields in the plurality of first data fields, generate an alteration datum as a function of the one or more discrepant data fields and the secondary data in a corresponding data field and update the one or more discrepant data fields of the plurality of first data fields as a function of the alteration datum.

### FIELD OF THE INVENTION

The present invention generally relates to the field of data structure analysis. In particular, the present invention is directed to an apparatus and method for resolving data discrepancies between a first data structure and a second data structure.

### BACKGROUND

In recent years, the management of data structures has become increasingly critical, where large volumes of data must be organized, processed, and validated. Traditional methods of manually managing and aligning data structures are often inefficient and prone to errors. As data structures grow in size and complexity, existing techniques have struggled to ensure accurate synchronization and validation across multiple systems, leading to delays, discrepancies, and compliance challenges. Thus, there is a need for more advanced solutions.

### SUMMARY OF THE DISCLOSURE

In an aspect, an apparatus for resolving data discrepancies between a first data structure and a second data structure is disclosed. The apparatus includes at least a processor and a memory communicatively connected to the at least a processor, wherein the memory contains instructions configuring the at least a processor to access a first data structure, wherein the first data structure includes a plurality of first data fields representing primary data, wherein the primary data includes document data, access a second data structure, wherein the second data structure includes a plurality of second data fields representing secondary data, identify one or more discrepant data fields in the plurality of first data fields by comparing the first data structure to the second data structure, wherein identifying the one or more discrepant data fields includes determining a corresponding data field from the plurality of second data fields as a function of the primary data and the one or more discrepant data fields is identified when a first data field of the plurality of first data fields does not match the corresponding data field of the plurality of second data fields, generate an alteration datum as a function of the one or more discrepant data fields and the secondary data in the corresponding data field and update the one or more discrepant data fields of the plurality of first data fields in the first data structure as a function of the alteration datum, wherein the alteration datum modifies the document data of the one or more discrepant data fields to conform with the secondary data of the corresponding data field.

In another aspect, a method for resolving data discrepancies between a first data structure and a second data structure is disclosed. The method includes accessing, using at least a processor, a first data structure, wherein the first data structure includes a plurality of first data fields representing primary data, wherein the primary data includes document data, accessing, using the at least a processor, a second data structure, wherein the second data structure includes a plurality of second data fields representing secondary data, identifying, using the at least a processor, one or more discrepant data fields in the plurality of first data fields by comparing the first data structure to the second data structure, wherein identifying the one or more discrepant data fields includes determining a corresponding data field from the plurality of second data fields as a function of the primary data and the one or more discrepant data fields is identified when a first data field of the plurality of first data fields does not match the corresponding data field of the plurality of second data fields, generating, using the at least a processor, an alteration datum as a function of the one or more discrepant data fields and the secondary data in the corresponding data field and updating, using the at least a processor, the one or more discrepant data fields of the plurality of first data fields in the first data structure as a function of the alteration datum, wherein the alteration datum modifies the document data of the one or more discrepant data fields to conform with the secondary data of the corresponding data field.

These and other aspects and features of non-limiting embodiments of the present invention will become apparent to those skilled in the art upon review of the following description of specific non-limiting embodiments of the invention in conjunction with the accompanying drawings.

### BRIEF DESCRIPTION OF THE DRAWINGS

For the purpose of illustrating the invention, the drawings show aspects of one or more embodiments of the invention. However, it should be understood that the present invention is not limited to the precise arrangements and instrumentalities shown in the drawings, wherein:

FIG. 1 illustrates a block diagram of an exemplary apparatus for resolving data discrepancies between a first data structure and a second data structure;

FIG. 2 illustrates an exemplary first data structure;

FIG. 3 illustrates an exemplary second data structure;

FIG. 4 illustrates a block diagram of an exemplary machine-learning module;

FIG. 5 illustrates a diagram of an exemplary neural network;

FIG. 6 illustrates a block diagram of an exemplary node in a neural network;

FIG. 7 illustrates an exemplary fuzzy set comparison;

FIG. 8 illustrates a flow diagram of an exemplary method for resolving data discrepancies between a first data structure and a second data structure; and

FIG. 9 illustrates a block diagram of a computing system that can be used to implement any one or more of the methodologies disclosed herein and any one or more portions thereof. The drawings are not necessarily to scale and may be illustrated by phantom lines, diagrammatic representations and fragmentary views. In certain instances, details that are not necessary for an understanding of the embodiments or that render other details difficult to perceive may have been omitted.

### DETAILED DESCRIPTION

At a high level, aspects of the present disclosure are directed to apparatuses and methods for resolving data discrepancies between a first data structure and a second data structure are disclosed. The apparatus includes at least a processor and a memory communicatively connected to the at least a processor, wherein the memory contains instructions configuring the at least a processor to access a first data structure, wherein the first data structure includes a plurality of first data fields representing primary data, wherein the primary data includes document data, access a second data structure, wherein the second data structure includes a plurality of second data fields representing secondary data, identify one or more discrepant data fields in the plurality of first data fields by comparing the first data structure to the second data structure, wherein identifying the one or more discrepant data fields includes determining a corresponding data field from the plurality of second data fields as a function of the primary data and the one or more discrepant data fields is identified when a first data field of the plurality of first data fields does not match the corresponding data field of the plurality of second data fields, generate an alteration datum as a function of the one or more discrepant data fields and the secondary data in the corresponding data field and update the one or more discrepant data fields of the plurality of first data fields in the first data structure as a function of the alteration datum, wherein the alteration datum modifies the document data of the one or more discrepant data fields to conform with the secondary data of the corresponding data field.

Aspects of the present disclosure can be used to resolve data discrepancies between two data structures and automatically update the data structures by generating alterations for the discrepancy in the data structures. Exemplary embodiments illustrating aspects of the present disclosure are described below in the context of several specific examples.

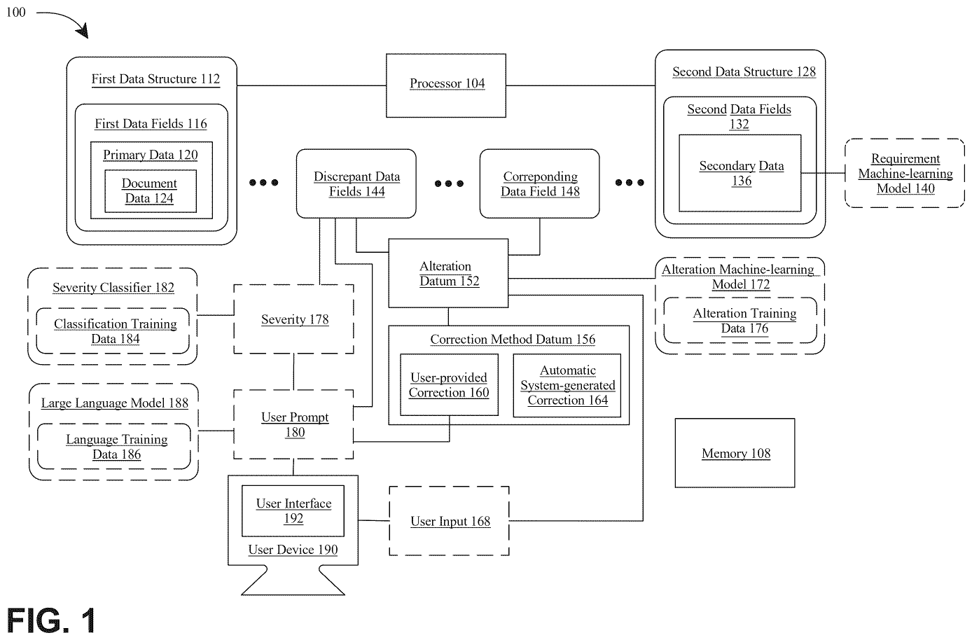

Referring now to FIG. 1, an exemplary embodiment of an apparatus 100 for resolving data discrepancies between a first data structure and a second data structure is illustrated. Apparatus 100 includes at least a processor 104. Processor 104 may include, without limitation, any processor described in this disclosure. Processor 104 may be included in a computing device. Processor 104 may include any computing device as described in this disclosure, including without limitation a microcontroller, microprocessor, digital signal processor (DSP) and/or system on a chip (SoC) as described in this disclosure. Processor 104 may include, be included in, and/or communicate with a mobile device such as a mobile telephone or smartphone. Processor 104 may include a single computing device operating independently, or may include two or more computing device operating in concert, in parallel, sequentially or the like; two or more computing devices may be included together in a single computing device or in two or more computing devices. Processor 104 may interface or communicate with one or more additional devices as described below in further detail via a network interface device. Network interface device may be utilized for connecting processor 104 to one or more of a variety of networks, and one or more devices. Examples of a network interface device include, but are not limited to, a network interface card (e.g., a mobile network interface card, a LAN card), a modem, and any combination thereof. Examples of a network include, but are not limited to, a wide area network (e.g., the Internet, an enterprise network), a local area network (e.g., a network associated with an office, a building, a campus or other relatively small geographic space), a telephone network, a data network associated with a telephone/voice provider (e.g., a mobile communications provider data and/or voice network), a direct connection between two computing devices, and any combinations thereof. A network may employ a wired and/or a wireless mode of communication. In general, any network topology may be used. Information (e.g., data, software etc.) may be communicated to and/or from a computer and/or a computing device. Processor 104 may include but is not limited to, for example, a computing device or cluster of computing devices in a first location and a second computing device or cluster of computing devices in a second location. Processor 104 May include one or more computing devices dedicated to data storage, security, distribution of traffic for load balancing, and the like. Processor 104 may distribute one or more computing tasks as described below across a plurality of computing devices of computing device, which may operate in parallel, in series, redundantly, or in any other manner used for distribution of tasks or memory between computing devices. Processor 104 may be implemented, as a non-limiting example, using a “shared nothing” architecture.

With continued reference to FIG. 1, processor 104 may be designed and/or configured to perform any method, method step, or sequence of method steps in any embodiment described in this disclosure, in any order and with any degree of repetition. For instance, processor 104 may be configured to perform a single step or sequence repeatedly until a desired or commanded outcome is achieved; repetition of a step or a sequence of steps may be performed iteratively and/or recursively using outputs of previous repetitions as inputs to subsequent repetitions, aggregating inputs and/or outputs of repetitions to produce an aggregate result, reduction or decrement of one or more variables such as global variables, and/or division of a larger processing task into a set of iteratively addressed smaller processing tasks. Processor 104 may perform any step or sequence of steps as described in this disclosure in parallel, such as simultaneously and/or substantially simultaneously performing a step two or more times using two or more parallel threads, processor cores, or the like; division of tasks between parallel threads and/or processes may be performed according to any protocol suitable for division of tasks between iterations. Persons skilled in the art, upon reviewing the entirety of this disclosure, will be aware of various ways in which steps, sequences of steps, processing tasks, and/or data may be subdivided, shared, or otherwise dealt with using iteration, recursion, and/or parallel processing.

With continued reference to FIG. 1, apparatus 100 includes a memory 108 communicatively connected to processor 104. For the purposes of this disclosure, “communicatively connected” means connected by way of a connection, attachment or linkage between two or more relata which allows for reception and/or transmittance of information therebetween. For example, and without limitation, this connection may be wired or wireless, direct or indirect, and between two or more components, circuits, devices, systems, and the like, which allows for reception and/or transmittance of data and/or signal(s) therebetween. Data and/or signals therebetween may include, without limitation, electrical, electromagnetic, magnetic, video, audio, radio and microwave data and/or signals, combinations thereof, and the like, among others. A communicative connection may be achieved, for example and without limitation, through wired or wireless electronic, digital or analog, communication, either directly or by way of one or more intervening devices or components. Further, communicative connection may include electrically coupling or connecting at least an output of one device, component, or circuit to at least an input of another device, component, or circuit. For example, and without limitation, via a bus or other facility for intercommunication between elements of a computing device. Communicative connecting may also include indirect connections via, for example and without limitation, wireless connection, radio communication, low power wide area network, optical communication, magnetic, capacitive, or optical coupling, and the like. In some instances, the terminology “communicatively coupled” may be used in place of communicatively connected in this disclosure.

With continued reference to FIG. 1, memory 108 contains instructions configuring processor 104 to access a first data structure 112. For the purposes of this disclosure, a “first data structure” is a structured organization of data related to primary data. First data structure 112 includes a plurality of first data fields 116 representing primary data 120. For the purposes of this disclosure, a “first data field” is a unit of information within a first data structure. For the purposes of this disclosure, “primary data” is data that is in its unprocessed form. In some embodiments, primary data 120 may include data related to a subject. As a non-limiting example, primary data 120 may include subject's name, date of birth, medical history, current diagnoses, treatment plans, insurance information, billing information, and the like. In some embodiments, each first data field 116 may include document data 124 and/or primary data 120. In a non-limiting example, each first data field 116 may include diagnosis codes, treatment records, procedure details, physician notes, and the like. For the purposes of this disclosure, a “subject” is an individual, entity, or group whose information is being collected. As a non-limiting example, subject may include a patient. Primary data 120 includes document data 124. For the purposes of this disclosure, “document data” is information within documents. As a non-limiting example, document data 124 may include electronic health record (EHR) data. For the purposes of this disclosure, an “electronic health record” is a systematized collection of patient and population electronically stored health information in a digital format. For example, and without limitation, document data 124 may include range of data, including patient demographics, patient identifier, medical history, medication and allergies, immunization status, laboratory test results, radiology images, vital signs, personal statistics like age and weight, billing information, insurance information, and the like. For example, and without limitation, document data 124 may include medical professional's note related to a subject. In a non-limiting example, document data 124 may include medical professional's notes related to diagnosis or treatment of a patient. As another non-limiting example, document data 124 may include a physician's note, test results, medical record, or other documentation.

With continued reference to FIG. 1, in some embodiments, processor 104 may be communicatively connected with first data structure 112. For example, and without limitation, in some cases, first data structure 112 may be local to processor 104. In another example, and without limitation, first data structure 112 may be remote to processor 104 and communicative with processor 104 by way of one or more networks. The network may include, but is not limited to, a cloud network, a mesh network, and the like. By way of example, a “cloud-based” system can refer to a system which includes software and/or data which is stored, managed, and/or processed on a network of remote servers hosted in the “cloud,” e.g., via the Internet, rather than on local severs or personal computers. A “mesh network” as used in this disclosure is a local network topology in which the infrastructure processor 104 connect directly, dynamically, and non-hierarchically to as many other computing devices as possible. A “network topology” as used in this disclosure is an arrangement of elements of a communication network. The network may use an immutable sequential listing to securely store first data structure 112. An “immutable sequential listing,” as used in this disclosure, is a data structure that places data entries in a fixed sequential arrangement, such as a temporal sequence of entries and/or blocks thereof, where the sequential arrangement, once established, cannot be altered or reordered. An immutable sequential listing may be, include and/or implement an immutable ledger, where data entries that have been posted to the immutable sequential listing cannot be altered.

With continued reference to FIG. 1, in some embodiments, first data structure 112 may include keywords. As used in this disclosure, a “keyword” is an element of word or syntax used to identify and/or match elements to each other. For example, without limitation, the keyword may include “patient identifier” in the instance that a user is looking for information related to a specific subject.

With continued reference to FIG. 1, in some embodiments, first data structure 112 may be implemented, without limitation, as a relational database, a key-value retrieval database such as a NOSQL database, or any other format or structure for use as a database that a person skilled in the art would recognize as suitable upon review of the entirety of this disclosure. Database may alternatively or additionally be implemented using a distributed data storage protocol and/or data structure, such as a distributed hash table or the like. Database may include a plurality of data entries and/or records as described above. Data entries in a database may be flagged with or linked to one or more additional elements of information, which may be reflected in data entry cells and/or in linked tables such as tables related by one or more indices in a relational database. Persons skilled in the art, upon reviewing the entirety of this disclosure, will be aware of various ways in which data entries in a database may store, retrieve, organize, and/or reflect data and/or records as used herein, as well as categories and/or populations of data consistently with this disclosure.

With continued reference to FIG. 1, in some embodiments, processor 104 may analyze primary data 120 or document data 124 using a language processing module. In some embodiments, processor 104 may use a language processing module to find a keyword. The language processing module may be configured to extract, from document data 124 or primary data 120, one or more words. One or more words may include, without limitation, strings of one or more characters, including without limitation any sequence or sequences of letters, numbers, punctuation, diacritic marks, medical symbols, medical codes, medical abbreviations, chemical symbols and formulas, spaces, whitespace, and other symbols, including any symbols usable as textual data. Textual data may be parsed into tokens, which may include a simple word (sequence of letters separated by whitespace) or more generally a sequence of characters as described previously. The term “token,” as used herein, refers to any smaller, individual groupings of text from a larger source of text; tokens may be broken up by word, pair of words, sentence, or other delimitation. These tokens may in turn be parsed in various ways. Textual data may be parsed into words or sequences of words, which may be considered words as well. Textual data may be parsed into “n-grams,” where all sequences of n consecutive characters are considered. Any or all possible sequences of tokens or words may be stored as “chains,” for example for use as a Markov chain or Hidden Markov Model.

With continued reference to FIG. 1, language processing module may operate to produce a language processing model. Language processing model may include a program automatically generated by processor 104 and/or language processing module to produce associations between one or more words extracted from at least a document (document data 124) and detect associations, including without limitation mathematical associations, between such words. Associations between language elements, where language elements include for purposes herein extracted words, relationships of such categories to other such term may include, without limitation, mathematical associations, including without limitation statistical correlations between any language element and any other language element and/or language elements. Statistical correlations and/or mathematical associations may include probabilistic formulas or relationships indicating, for instance, a likelihood that a given extracted word indicates a given category of semantic meaning. As a further example, statistical correlations and/or mathematical associations may include probabilistic formulas or relationships indicating a positive and/or negative association between at least an extracted word and/or a given semantic meaning; positive or negative indication may include an indication that a given document is or is not indicating a category semantic meaning. Whether a phrase, sentence, word, or other textual element in a document or corpus of documents constitutes a positive or negative indicator may be determined, in an embodiment, by mathematical associations between detected words, comparisons to phrases and/or words indicating positive and/or negative indicators that are stored in memory at computing device, or the like.

With continued reference to FIG. 1, language processing module may generate the language processing model by any suitable method, including without limitation a natural language processing classification algorithm; language processing model may include a natural language process classification model that enumerates and/or derives statistical relationships between input terms and output terms. Algorithm to generate language processing model may include a stochastic gradient descent algorithm, which may include a method that iteratively optimizes an objective function, such as an objective function representing a statistical estimation of relationships between terms, including relationships between input terms and output terms, in the form of a sum of relationships to be estimated. In an alternative or additional approach, sequential tokens may be modeled as chains, serving as the observations in a Hidden Markov Model (HMM). HMMs, as used herein, are statistical models with inference algorithms that that may be applied to the models. In such models, a hidden state to be estimated may include an association between an extracted words, phrases, and/or other semantic units. There may be a finite number of categories to which an extracted word may pertain; an HMM inference algorithm, such as the forward-backward algorithm or the Viterbi algorithm, may be used to estimate the most likely discrete state given a word or sequence of words. Language processing module may combine two or more approaches. For instance, and without limitation, machine-learning program may use a combination of Naive-Bayes (NB), Stochastic Gradient Descent (SGD), and parameter grid-searching classification techniques; the result may include a classification algorithm that returns ranked associations.

With continued reference to FIG. 1, generating language processing model may include generating a vector space, which may be a collection of vectors, defined as a set of mathematical objects that can be added together under an operation of addition following properties of associativity, commutativity, existence of an identity element, and existence of an inverse element for each vector, and can be multiplied by scalar values under an operation of scalar multiplication compatible with field multiplication, and that has an identity element is distributive with respect to vector addition, and is distributive with respect to field addition. Each vector in an n-dimensional vector space may be represented by an n-tuple of numerical values. Each unique extracted word and/or language element as described above may be represented by a vector of the vector space. In an embodiment, each unique extracted and/or other language element may be represented by a dimension of vector space; as a non-limiting example, each element of a vector may include a number representing an enumeration of co-occurrences of the word and/or language element represented by the vector with another word and/or language element. Vectors may be normalized, scaled according to relative frequencies of appearance and/or file sizes. In an embodiment associating language elements to one another as described above may include computing a degree of vector similarity between a vector representing each language element and a vector representing another language element; vector similarity may be measured according to any norm for proximity and/or similarity of two vectors, including without limitation cosine similarity, which measures the similarity of two vectors by evaluating the cosine of the angle between the vectors, which can be computed using a dot product of the two vectors divided by the lengths of the two vectors. Degree of similarity may include any other geometric measure of distance between vectors.

With continued reference to FIG. 1, language processing module may use a corpus of documents to generate associations between language elements in a language processing module may then use such associations to analyze words extracted from one or more documents and determine that the one or more documents indicate significance of a category. In an embodiment, language module and/or processor 104 may perform this analysis using a selected set of significant documents, such as documents identified by one or more experts as representing good information; experts may identify or enter such documents via graphical user interface or may communicate identities of significant documents according to any other suitable method of electronic communication, or by providing such identity to other persons who may enter such identifications into processor 104. Documents may be entered into a computing device by being uploaded by an expert or other persons using, without limitation, file transfer protocol (FTP) or other suitable methods for transmission and/or upload of documents; alternatively or additionally, where a document is identified by a citation, a uniform resource identifier (URI), uniform resource locator (URL) or other datum permitting unambiguous identification of the document, processor 104 may automatically obtain the document using such an identifier, for instance by submitting a request to a database or compendium of documents such as JSTOR as provided by Ithaka Harbors, Inc. of New York.

With continued reference to FIG. 1, memory 108 contains instructions configuring processor 104 to access a second data structure 128. For the purposes of this disclosure, a “second data structure” a structured organization of data related to secondary data. Second data structure 128 includes a plurality of second data fields 132 representing secondary data 136. For the purposes of this disclosure, a “second data field” is a unit of information within a second data structure. For the purposes of this disclosure, “secondary data” is data that has already been collected, processed, or compiled by other sources. In some embodiments, each second data field 132 may include secondary data 136. As a non-limiting example, each second data field 132 may include conditions, rules or payor requirements, and the like. For example, and without limitation, each second data field 132 may include a list of required documentation, required information, standards, and the like. For the purposes of this disclosure, “payor requirement” is a set of criteria, conditions, or documentation standards that primary data must met. Payor requirement may be set by a third party. As a non-limiting example, payor requirement may include specific documentation or evidence, information, and the like. For the purposes of this disclosure, a “third party” is an individual, group, or organization that is not a user. As a non-limiting example, third party may include insurance companies, government health programs (e.g., Medicare, Medicaid), or other entities.

With continued reference to FIG. 1, in some embodiments, secondary data 136 may be collected, processed, or compiled by one or more third parties (e.g., third party input). For the purposes of this disclosure, a “third party input” is data input by a third party. In some embodiments, secondary data 136 may be collected, processed, or compiled by a plurality of machine-learning models. In some embodiments, secondary data 136 may include an output of a requirement machine-learning model 140. For the purposes of this disclosure, a “requirement machine-learning model” is a machine-learning model that generates secondary data. In some embodiments, requirement machine-learning model 140 may be trained with requirement training data, wherein the requirement training data including exemplary secondary data. Additional disclosure related to requirement machine-learning model 140 may be found in U.S. Nonprovisional patent application Ser. No. 18/957,785, filed on Nov. 24, 2024, and titled “SYSTEM AND METHOD FOR DETERMINING A PRIORITIZED ARRAY OF ASSOCIATED DATASETS,” the entirety of which is incorporated as a reference.

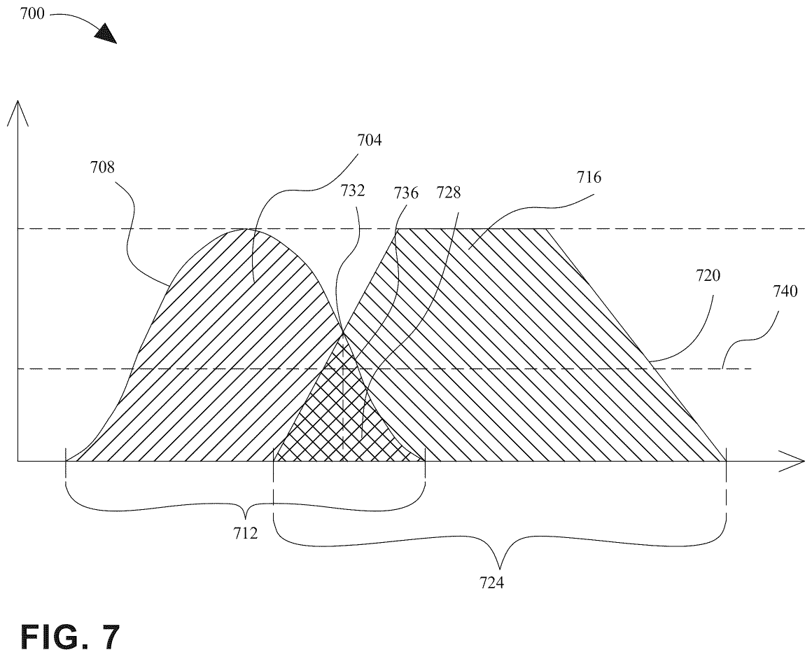

With continued reference to FIG. 1, memory 108 contains instructions configuring processor 104 to identify one or more discrepant data fields 144 in a plurality of first data fields 116 by comparing first data structure 112 to second data structure 128. For the purposes of this disclosure, a “discrepant data field” is a data field in a first data structure that does not match a corresponding data field of a plurality of second data fields. Identifying one or more discrepant data fields 144 includes determining a corresponding data field 148 from a plurality of second data fields 132 as a function of primary data 120. For the purposes of this disclosure, a “corresponding data field” is a second data field that has a direct relationship or linkage to a first data field. In a non-limiting example, processor 104 may compare first data structure 112 to second data structure 128 to determine whether a plurality of first data fields 116 contains all of the data present in a plurality of second data fields 132. For example, and without limitation, processor 104 may compare first data structure 112, which contains a patient's medical records (e.g., primary data 120) in a plurality of first data fields 116, to second data structure 128, which contains insurance requirements (e.g., secondary data 136) in a plurality of second data fields 132, to determine whether the plurality of first data fields 116, such as diagnosis codes and treatment descriptions, contains all of the requirements in the plurality of second data fields 132, such as required documentation. In some embodiments, processor 104 may identify discrepant data fields 144 using fuzzy set comparison. The fuzzy set comparison is further described in FIG. 7.

With continued reference to FIG. 1, in some embodiments, determining a corresponding data field 148 may include mapping first data fields 116 and second data fields 132 using predefined mapping logic to align each first data field 116 of first data structure 112 with second data field 132 in second data structure 128 that corresponds to the first data field 116. In one embodiment, mapping logic may be implemented using configuration files or schema definitions that explicitly specify which fields should be compared. For instance, and without limitation, a mapping configuration may define that the “Diagnosis Code” in primary data 120 corresponds to the “Required Diagnosis Code” in secondary data 136. In some embodiments, processor 104 may identify one or more discrepant data fields 144 in a plurality of first data fields 116 if a mismatch is found during comparison. For example, and without limitation, if one first data field 116 of first data structure 112 contains a diagnosis code “J45.909” (primary data 120), but one corresponding data field 148 of second data structure 128 contains only “J45.991” (secondary data 136), processor 104 identify the first data field 116 as discrepant data field 144. For example, and without limitation, processor 104 may compare document data 124 in first data fields 116 with predefined documentation requirements (secondary data 136) in corresponding data field 148.

With continued reference to FIG. 1, in some embodiments, processor 104 may identify discrepant data fields 144 using an encoder. For the purposes of this disclosure, an “encoder” is a component or system that transforms input data from texts into a numerical representation or vector format. In some embodiments, encoder may include recurrent neural network (RNN) encoder, long short-term memory (LSTM) encoder, transformer encoder, autoencoder, and the like. For the purposes of this disclosure, “encoding” refers to a process of transforming data from one format or structure into another. In some embodiments, encoder may convert primary data 120, first data fields 116, or first data structure 112 and secondary data 136, second data fields 132, or second data structure 128 into vector representations and processor 104 may compare the vector representations to identify discrepant data fields 144.

With continued reference to FIG. 1, in some embodiments, encoder may include BERT. In an embodiment, BERT may implement a transformer architecture having an “attention mechanism” configured to dynamically determine and assign weight e.g., importance of different tokens such as text characters, words, or the like. Exemplary attention mechanism may include, without limitation, generalized attention self-attention, multi-head attention, additive attention, global attention, and the like. In some cases, transformer architecture may be implemented as an encoder-decoder structure having an encoder configured to map an input sequence to a higher dimensional space i.e., a sequence of continuous representations, and a decoder configured to transform output of the encoder into a final output sequence, such as without limitation an embedding representing a nucleotide sequence. In other cases, transformer architecture may include only an encoder stack. As a non-limiting example, BERT may include a plurality of layers each contains one or more sub-layers, wherein a first sub-layer may include a multi-head self-attention mechanism, and a second sub-layer may include a position-wise fully connected feed-forward network. In some cases, plurality of layers may be identical. In some cases, multi-head self-attention mechanism may configure BERT to focus on different parts of the input sequence when predicting elements of an embedding to be output; for instance, and without limitation, self-attention mechanism may be described by an attention function:

$$Attention ( Q , K , V ) = soft max ( \frac{{QK}^{T}}{\sqrt{{d}_{k}}} ) V$$

Where Q, K, and V represent a set of queries, keys, and values matrices respectively, and dₖ is the dimensionality of the keys. In a non-limiting embodiment, in the context of analysis of RNA, a self-attention mechanism may take output of previous layer X and produce outputs C, using weight matrices

$${W}_{i}^{V}$$

based on query matrix

$${Q}_{i} = [ {q}_{1}^{i} , … , {q}_{n}^{i} ]$$

key matrix

$${K}_{i} = [ {k}_{1}^{i} , … , {k}_{n}^{i} ] ,$$

and value matrix

$${V}_{i} = [ {v}_{1}^{i} , … , {v}_{n}^{i} ]$$

as follows:

$$C = Concat ( {head}_{1} , … , {head}_{H} ) {W}^{O} ( inner product with the W one )$$

$${head}_{i} = soft max ( \frac{( {Q}_{i} ) {( {K}_{i} )}^{T}}{\sqrt{D}} ) {V}_{i}$$

$$where$$

$${Q}_{i} = {XW}_{i}^{Q} , {K}_{i} = {XW}_{i}^{K} , {V}_{i} = {XW}_{i}^{V}$$

representing inner products with sets of weights

$${W}_{i}^{Q} , {W}_{i}^{K} , and {W}_{i}^{V} ,$$

which are the weights to be tuned when training BERT. These matrices may be of size D×D that where D is the input and output vector dimension, which may be, as a non-limiting example, 120 elements. In the above-described example, each head may calculate a subsequent hidden state by computing an attention-weighted sum of a value vector v.

In some cases, and still referring to FIG. 1, position-wise fully connected feed-forward network within second sub-layer of each layer may apply a linear transformation to each position separately and identically, for example, and without limitation, position-wise fully connected feed-forward network may be configured to process the output of the attention mechanism according to equation FFN(x)=max(0, xW₁+b₁)W₂+b₂, where W₁, W₂, b₁, and b₂ are parameters of the feed-forward and x is the input to the feed-forward network. In other words, second sub-layer may include two convolutions with a kernel size 1 and a ReLu activation in between.

With continued reference to FIG. 1, in one or more embodiments, BERT's input representation may combine a plurality of embeddings of tokens, segments, and/or positions. In some cases, each token may be processed, for example and without limitation, through a WordPiece tokenization. Output of BERT may include a fixed-length vector that represents the input token's contextual relationships that suitable for downstream tasks, such as, without limitation, processes describe above. In some cases, implementing BERT for generation of representations of may include pre-training (bidirectionally) which involves one or more unsupervised tasks; for instance, and without limitation, processor 104 may be configured to execute a Masked Language Model (MLM) and a Next Sentence Prediction (NSP). In a non-limiting example, at least a portion of nucleotide sequence in each nucleotide sequence example may be randomly masked, and the model may learn to predict masked nucleotide sequence portions based on the context. NSP may train the model to predict, for example, and without limitation, whether two given subsequences logically follow each other. Additionally, BERT may be fine-tuned to adapt pre-trained representations. In some cases, fine-tuning BERT may include iteratively training BERT's parameters on structural alignment learning and/or masked language model learning with minimal adjustments required from the pre-trained model as described above; for instance, and without limitation, a loss function used for fine-turning may be represented as:

$$L = - log ( \frac{{e}^{s ( correct )}}{{\sum }_{j}^{n} {e}^{s ( j )}} )$$

Wherein L is the loss, s (correct) is the score of the correct label, and s(j) is the score of each possible label. It should be noted that other exemplary downstream tasks e.g., sentiment analysis, question answering, named entity recognition (NER), among others may be adapted and optimized based on the apparatus and methods described in this disclosure. As a person skilled in the art, upon reviewing the entirety of this disclosure, will be well versed in the model architectures, including multi-head self-attention mechanism and position-wise fully connected feed-forward network as described herein.

With continued reference to FIG. 1, in some embodiments, processor 104 may be configured to generate discrepancy training data. In a non-limiting example, discrepancy training data may include correlations between exemplary primary data, exemplary secondary data and exemplary discrepant data fields. In some embodiments, discrepancy training data may be stored in database. In some embodiments, discrepancy training data may be received from one or more users, database, external computing devices, and/or previous iterations of processing. As a non-limiting example, discrepancy training data may include instructions from a user, who may be an expert user, a past user in embodiments disclosed herein, or the like, which may be stored in memory and/or stored in database, where the instructions may include labeling of training examples. In some embodiments, discrepancy training data may be updated iteratively on a feedback loop. As a non-limiting example, processor 104 may update discrepancy training data iteratively through a feedback loop as a function of primary data 120, secondary data 136, or the like. In some embodiments, processor 104 may be configured to generate discrepancy machine-learning model. In a non-limiting example, generating discrepancy machine-learning model may include training, retraining, or fine-tuning discrepancy machine-learning model using discrepancy training data or updated discrepancy training data. In some embodiments, processor 104 may be configured to identify discrepant data fields 144 from first data structure 112 and second data structure 128 using discrepancy machine-learning model (i.e. trained or updated discrepancy machine-learning model). In some embodiments, generating training data and training machine-learning models may be simultaneous. In some embodiments, processor 104 may identify discrepant data fields 144 using a natural language processing. The natural language processing is further described in this disclosure.

With continued reference to FIG. 1, memory 108 contains instructions configuring processor 104 to generate an alteration datum 152 as a function of one or more discrepant data fields 144 and secondary data 136 in corresponding data field 148. For the purposes of this disclosure, an “alteration datum” is a data element that represents a proposed modification or adjustment to a first data field 116. As a non-limiting example, alteration datum 152 may include adding, updating, or replacing specific values in a first data field 116. For example, and without limitation, if a diagnosis code (discrepant data field 144) does not match required codes (corresponding data field 148), alteration datum 152 may include a different diagnosis code that is compliant with secondary data 136 in corresponding data field 148.

With continued reference to FIG. 1, in some embodiments, generating alteration datum 152 may include determining a correction method datum 156 as a function of one or more discrepant data fields 144 and generating alteration datum 152 as a function of correction method datum 156. For the purposes of this disclosure, a “correction method datum” is a data element that represents a method of correcting or updating a discrepant data field. In some embodiments, determining the correction method datum 156 may include determining whether one or more discrepant data fields 144 needs user-provided corrections 160 or automatic system-generated corrections 164. For the purposes of this disclosure, “user-provided correction” is a modification or adjustment that can be made to a discrepant data field by a user. As a non-limiting example, in the context of user-provided correction 160, processor 104 may generate alteration datum 152 using a user input 168 as described below. For the purposes of this disclosure, “automatic system-generated correction” is a modification or adjustment that can be performed by a processor without direct human intervention. As a non-limiting example, in the context of automatic system-generated correction 164, processor 104 may generate alteration datum 152 using an alteration machine-learning model 172 as described below. In some embodiments, processor 104 may determine correction method datum 156 as a function of whether processor 104 has access to rules, algorithms, or machine learning models (e.g., alteration machine-learning model 172) that can accurately generate alteration datum 152. For example, and without limitation, if rules for generating alteration datum 152 are not clearly defined or if generation of alteration datum 152 depends on external factors that are not captured in training data for machine-learning models (e.g., alteration training data 176 for alteration machine-learning model 172), user-provided correction 160 may be determined.

With continued reference to FIG. 1, in some embodiments, generating alteration datum 152 may include categorizing one or more discrepant data fields 144 based on its severity 178, wherein a discrepant data field 144 with a high severity 178 may trigger generation of user prompt 180. In some embodiments, user prompt 180 may include a notification. For the purposes of this disclosure, “severity” of a discrepant data field refers to a level of impact or importance associated with a discrepant data field. In a non-limiting example, severity 178 of a discrepant data field 144 may indicate how much a discrepancy in discrepant data field 144 affects processes like claim approval or compliance associated with third party. For example, and without limitation, discrepant data field 144 with high severity 178 may cause an outright denial of a claim by a third party, while discrepant data field 144 with low severity 178 may cause a minor delay in processing of a claim by a third party. As a non-limiting example, discrepant data field 144 with high severity 178 may indicate issues like missing required documentation that is essential for meeting legal requirements, while discrepant data field 144 with low severity 178 may relate to non-critical formatting issues that do not affect overall compliance. For the purposes of this disclosure, a “notification” is a message or alert to inform a user about a specific event or change. As a non-limiting example, notification may alert a user related to discrepant data fields 144.

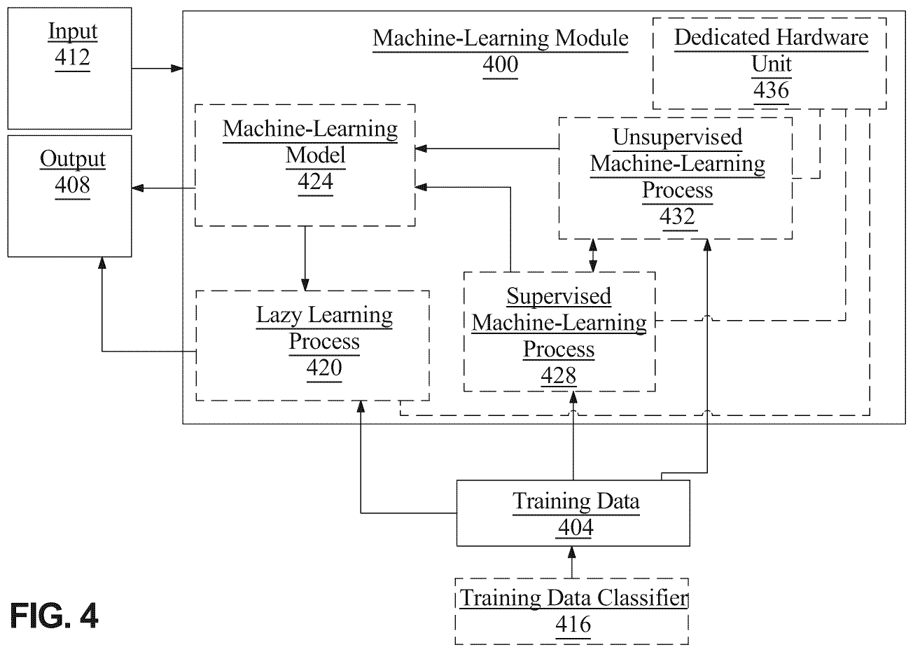

With continued reference to FIG. 1, in some embodiments, processor 104 may categorize discrepant data fields 144 using a severity classifier 182. For the purposes of this disclosure, a “severity classifier” is a machine-learning model, such as a mathematical model, neural net, or program generated by a machine learning algorithm known as a “classification algorithm,” that sorts discrepant data field related inputs into categories or bins of data, outputting severities 178 associated therewith. The severity classifier 182 disclosed herein may be consistent with a classifier disclosed with respect to FIG. 4. In some embodiments, severity classifier 182 may be trained with classification training data 184 correlating a plurality of discrepant data fields 144 to severities 178. The training data disclosed herein is further disclosed with respect to FIG. 4. In some embodiments, classification training data 184 may be stored in a database. In some embodiments, classification training data 184 may be received from one or more users, database, external computing devices, and/or previous iterations of processing. As a non-limiting example, classification training data 184 may include instructions from a user, who may be an expert user, a past user in embodiments disclosed herein, or the like, which may be stored in memory and/or stored in database, where the instructions may include labeling of training examples. In some embodiment, severity classifier 182 may be trained with classification training data 184 correlating a plurality of discrepant data fields 144 to severities 178. As a non-limiting example, classification training data 184 may correlate discrepant data field 144 with format issues to a low severity. As another non-limiting example, classification training data 184 may correlate discrepant data field 144 with missing specific codes to a high severity. Examples are merely examples and persons skilled in the art, upon reviewing the entirety of this disclosure, may appreciate various classification training data 184 that can be used in apparatus 100.

With continued reference to FIG. 1, in some embodiments, generating alteration datum 152 may include generating a user prompt 180 as a function of one or more discrepant data fields 144. For the purposes of this disclosure, a “user prompt” is a prompt related to a discrepant data field that can be sent to a user. As a non-limiting example, user prompt 180 may include a notification, message, alert, and the like. In a non-limiting example, user prompt 180 may be configured to prompt a user to correct one or more discrepant data fields (e.g., user-provided correction 160). In some embodiments, generating user prompt 180 may include generating language training data 186. For the purposes of this disclosure, “language training data” is data containing correlations that a machine-learning process may use to model relationships between discrepant data fields and user prompts. In some embodiments, language training data 186 may include exemplary discrepant data fields correlated to exemplary user prompts. In some embodiments, generating user prompt 180 may include training a large language model 188 using language training data 186 and generating user prompt 180 using the trained large language model 188. A “large language model,” as used herein, is a deep learning algorithm that can recognize, summarize, translate, predict and/or generate text and other content based on knowledge gained from massive datasets. LLM 188 may be a type of generative artificial intelligence (AI). LLMs 188 may be trained on large sets of data; for example, training sets may include greater than 1 million words. Training sets may be drawn from diverse sets of data such as, as non-limiting examples, novels, blog posts, articles, emails, and the like. Training sets may include a variety of subject matters, such as, as nonlimiting examples, medical tests, romantic ballads, beat poetry, emails, advertising documents, newspaper articles, and the like. LLMs 188, in some embodiments, may include GPT, GPT-2, GPT-3, and other language processing models. LLM 188 may be used to augment the text in an article based on a prompt. LLM 188 may include a text prediction based algorithm configured to receive an article and apply a probability distribution to the words already typed in a sentence to work out the most likely word to come next in augmented articles. For example, if the words already typed are “Nice to meet,” then it is highly likely that the word “you” will come next. LLM 188 may output such predictions by ranking words by likelihood or a prompt parameter. For the example given above, the LLM 188 may score “you” as the most likely, “your” as the next most likely, “his” or “her” next, and the like.

With continued reference to FIG. 1, LLM 188 may include an attention mechanism utilizing a transformer as described further below. An “attention mechanism,” as used herein, is a part of a neural architecture that enables a system to dynamically highlight relevant features of the input data. In natural language processing this may be a sequence of textual elements. It may be applied directly to the raw input or to its higher-level representation. An attention mechanism may be an improvement to the limitation of the Encoder-Decoder model which encodes the input sequence to one fixed length vector from which to decode the output at each time step. This issue may be seen as a problem when decoding long sequences because it may make it difficult for the neural network to cope with long sentences, such as those that are longer than the sentences in the training corpus. Applying an attention mechanism, LLM 188 may predict the next word by searching for a set of position in a source sentence where the most relevant information is concentrated. LLM 188 may then predict the next word based on context vectors associated with these source positions and all the previous generated target words, such as textual data of a dictionary correlated to a prompt in a training data set. A “context vector,” as used herein, are fixed-length vector representations useful for document retrieval and word sense disambiguation. In some embodiments, LLM 188 may include encoder-decoder model incorporating an attention mechanism.

With continued reference to FIG. 1, LLM 188 may include a transformer architecture. In some embodiments, encoder component of LLM 188 may include transformer architecture. A “transformer architecture,” for the purposes of this disclosure is a neural network architecture that uses self-attention and positional encoding. Transformer architecture may be designed to process sequential input data, such as natural language, with applications towards tasks such as translation and text summarization. Transformer architecture may process the entire input all at once. “Positional encoding,” for the purposes of this disclosure, refers to a data processing technique that encodes the location or position of an entity in a sequence. In some embodiments, each position in the sequence may be assigned a unique representation. In some embodiments, positional encoding may include mapping each position in the sequence to a position vector. In some embodiments, trigonometric functions, such as sine and cosine, may be used to determine the values in the position vector. In some embodiments, position vectors for a plurality of positions in a sequence may be assembled into a position matrix, wherein each row of position matrix may represent a position in the sequence.

With continued reference to FIG. 1, an attention mechanism may represent an improvement over a limitation of the Encoder-Decoder model. The encoder-decider model encodes the input sequence to one fixed length vector from which the output is decoded at each time step. This issue may be seen as a problem when decoding long sequences because it may make it difficult for the neural network to cope with long sentences, such as those that are longer than the sentences in the training corpus. Applying an attention mechanism, LLM 188 may predict the next word by searching for a set of position in a source sentence where the most relevant information is concentrated. LLM 188 may then predict the next word based on context vectors associated with these source positions and all the previous generated target words, such as textual data of a dictionary correlated to a prompt in a training data set. A “context vector,” as used herein, are fixed-length vector representations useful for document retrieval and word sense disambiguation.

With continued reference to FIG. 1, an attention mechanism may include generalized attention self-attention, multi-head attention, additive attention, global attention, and the like. In generalized attention, when a sequence of words or an image is fed to LLM 188, it may verify each element of the input sequence and compare it against the output sequence. Each iteration may involve the mechanism's encoder capturing the input sequence and comparing it with each element of the decoder's sequence. From the comparison scores, the mechanism may then select the words or parts of the image that it needs to pay attention to. In self-attention, LLM 188 may pick up particular parts at different positions in the input sequence and over time compute an initial composition of the output sequence. In multi-head attention, LLM 188 may include a transformer model of an attention mechanism. Attention mechanisms, as described above, may provide context for any position in the input sequence. For example, if the input data is a natural language sentence, the transformer does not have to process one word at a time. In multi-head attention, computations by LLM 188 may be repeated over several iterations, each computation may form parallel layers known as attention heads. Each separate head may independently pass the input sequence and corresponding output sequence element through a separate head. A final attention score may be produced by combining attention scores at each head so that every nuance of the input sequence is taken into consideration. In additive attention (Bahdanau attention mechanism), LLM 188 may make use of attention alignment scores based on a number of factors. These alignment scores may be calculated at different points in a neural network. Source or input sequence words are correlated with target or output sequence words but not to an exact degree. This correlation may take into account all hidden states and the final alignment score is the summation of the matrix of alignment scores. In global attention (Luong mechanism), in situations where neural machine translations are required, LLM 188 may either attend to all source words or predict the target sentence, thereby attending to a smaller subset of words.

With continued reference to FIG. 1, multi-headed attention in encoder may apply a specific attention mechanism called self-attention. Self-attention allows the models to associate each word in the input, to other words. So, as a non-limiting example, the LLM 188 may learn to associate the word “you”, with “how” and “are”. It's also possible that LLM 188 learns that words structured in this pattern are typically a question and to respond appropriately. In some embodiments, to achieve self-attention, input may be fed into three distinct fully connected layers to create query, key, and value vectors. The query, key, and value vectors may be fed through a linear layer; then, the query and key vectors may be multiplied using dot product matrix multiplication in order to produce a score matrix. The score matrix may determine the amount of focus for a word should be put on other words (thus, each word may be a score that corresponds to other words in the time-step). The values in score matrix may be scaled down. As a non-limiting example, score matrix may be divided by the square root of the dimension of the query and key vectors. In some embodiments, the softmax of the scaled scores in score matrix may be taken. The output of this softmax function may be called the attention weights. Attention weights may be multiplied by your value vector to obtain an output vector. The output vector may then be fed through a final linear layer.

With continued reference to FIG. 1, in order to use self-attention in a multi-headed attention computation, query, key, and value may be split into N vectors before applying self-attention. Each self-attention process may be called a “head.” Each head may produce an output vector and each output vector from each head may be concatenated into a single vector. This single vector may then be fed through the final linear layer discussed above. In theory, each head can learn something different from the input, therefore giving the encoder model more representation power.

With continued reference to FIG. 1, encoder of transformer may include a residual connection. Residual connection may include adding the output from multi-headed attention to the positional input embedding. In some embodiments, the output from residual connection may go through a layer normalization. In some embodiments, the normalized residual output may be projected through a pointwise feed-forward network for further processing. The pointwise feed-forward network may include a couple of linear layers with a ReLU activation in between. The output may then be added to the input of the pointwise feed-forward network and further normalized.

With continued reference to FIG. 1, transformer architecture may include a decoder. Decoder may a multi-headed attention layer, a pointwise feed-forward layer, one or more residual connections, and layer normalization (particularly after each sub-layer), as discussed in more detail above. In some embodiments, decoder may include two multi-headed attention layers. In some embodiments, decoder may be autoregressive. For the purposes of this disclosure, “autoregressive” means that the decoder takes in a list of previous outputs as inputs along with encoder outputs containing attention information from the input.

With continued reference to FIG. 1, in some embodiments, input to decoder may go through an embedding layer and positional encoding layer in order to obtain positional embeddings. Decoder may include a first multi-headed attention layer, wherein the first multi-headed attention layer may receive positional embeddings.

With continued reference to FIG. 1, first multi-headed attention layer may be configured to not condition to future tokens. As a non-limiting example, when computing attention scores on the word “am,” decoder should not have access to the word “fine” in “I am fine,” because that word is a future word that was generated after. The word “am” should only have access to itself and the words before it. In some embodiments, this may be accomplished by implementing a look-ahead mask. Look ahead mask is a matrix of the same dimensions as the scaled attention score matrix that is filled with “0s” and negative infinities. For example, the top right triangle portion of look-ahead mask may be filed with negative infinities. Look-ahead mask may be added to scaled attention score matrix to obtain a masked score matrix. Masked score matrix may include scaled attention scores in the lower-left triangle of the matrix and negative infinities in the upper-right triangle of the matrix. Then, when the SoftMax of this matrix is taken, the negative infinities will be zeroed out; this leaves “zero” attention scores for “future tokens.”

With continued reference to FIG. 1, second multi-headed attention layer may use encoder outputs as queries and keys and the outputs from the first multi-headed attention layer as values. This process matches the encoder's input to the decoder's input, allowing the decoder to decide which encoder input is relevant to put a focus on. The output from second multi-headed attention layer may be fed through a pointwise feedforward layer for further processing.

With continued reference to FIG. 1, the output of the pointwise feedforward layer may be fed through a final linear layer. This final linear layer may act as a classifier. This classifier may be as big as the number of classes that you have. For example, if you have 10,000 classes for 10,000 words, the output of that classes will be of size 10,000. The output of this classifier may be fed into a SoftMax layer which may serve to produce probability scores between zero and one. The index may be taken of the highest probability score in order to determine a predicted word.

With continued reference to FIG. 1, decoder may take this output and add it to the decoder inputs. Decoder may continue decoding until a token is predicted. Decoder may stop decoding once it predicts an end token. In some embodiment, decoder may be stacked N layers high, with each layer taking in inputs from the encoder and layers before it. Stacking layers may allow LLM 188 to learn to extract and focus on different combinations of attention from its attention heads.

With continued reference to FIG. 1, in some embodiments, LLM 188 may be specifically trained using language training data 186. In some embodiments, language training data 186 may include a set of data that is in user's voice, email, or the like to mimic them. In some embodiments, language training data 186 may be consistent with any training data described in the entirety of this disclosure. In some embodiments, language training data 186 may be received from one or more users, database, external computing devices, and/or previous iterations of processing. As a non-limiting example, language training data 186 may include instructions from a user, who may be an expert user, a past user in embodiments disclosed herein, or the like, which may be stored in memory and/or stored in database, where the instructions may include labeling of training examples. In some embodiments, language training data 186 may be updated iteratively through a feedback loop. As a non-limiting example, language training data 186 may be updated iteratively through a feedback loop as a function of newly collected primary data 120, secondary data 136, output of machine-learning models described herein, or the like. In a non-limiting example, generating LLM may include training, retraining, or fine-tuning LLM using language training data 186 or updated language training data 186.

With continued reference to FIG. 1, in some embodiments, generating user prompt 180 may include transmitting user prompt 180 to a user device 190, receiving a user input 168 from the user device 190 as a function of user prompt 180 and generating alteration datum 152 as a function of the user input 168. For the purposes of this disclosure, a “user device” is any device a user use to input data. As a non-limiting example, user device 190 may include a laptop, desktop, tablet, mobile phone, smart phone, smart watch, kiosk, screen, smart headset, or things of the like. In some embodiments, user device 190 may include an interface configured to receive inputs from user as described below. In some embodiments, user may manually input any data into apparatus 100 using user device 190. In some embodiments, user may have a capability to process, store or transmit any information independently. For the purposes of this disclosure, a “user” is an individual or group that uses an apparatus 100. For the purposes of this disclosure, a “user input” is any data input by a user. As a non-limiting example, user input 168 may include alteration datum 152.

With continued reference to FIG. 1, in some embodiment, processor 104 may receive user input 168 from a user interface 192 manipulated by a user. For the purposes of this disclosure, a “user interface” is a means by which a user and a computer system interact; for example through the use of input devices and software. A user interface 192 may include a graphical user interface 192 (GUI), command line interface (CLI), menu-driven user interface 192, touch user interface 192, voice user interface 192 (VUI), form-based user interface 192, any combination thereof and the like. In some embodiments, user interface 192 may operate on and/or be communicatively connected to a decentralized platform, metaverse, and/or a decentralized exchange platform associated with the user. For example, a user may interact with user interface 192 in virtual reality. In some embodiments, a user may interact with the user interface 192 using a computing device distinct from and communicatively connected to at least a processor 104. For example, a smart phone, smart, tablet, or laptop operated by a user. In an embodiment, user interface 192 may include a graphical user interface. A “graphical user interface,” as used herein, is a graphical form of user interface that allows users to interact with electronic devices. In some embodiments, GUI may include icons, menus, other visual indicators or representations (graphics), audio indicators such as primary notation, and display information and related user controls. A menu may contain a list of choices and may allow users to select one from them. A menu bar may be displayed horizontally across the screen such as pull-down menu. When any option is clicked in this menu, then the pull-down menu may appear. A menu may include a context menu that appears only when the user performs a specific action. An example of this is pressing the right mouse button. When this is done, a menu may appear under the cursor. Files, programs, web pages and the like may be represented using a small picture in a graphical user interface. For example, links to decentralized platforms as described in this disclosure may be incorporated using icons. Using an icon may be a fast way to open documents, run programs etc. because clicking on them yields instant access.

With continued reference to FIG. 1, in some embodiments, generating alteration datum 152 may include generating alteration training data 176. For the purposes of this disclosure, “alteration training data” is data containing correlations that a machine-learning process may use to model relationships between discrepancy data field and alteration datum. In some embodiments, alteration training data 176 may include exemplary discrepancy data fields correlated to exemplary alteration data. In some embodiments, generating alteration datum 152 may include training an alteration machine-learning model 172 using alteration training data 176 and generating alteration datum 152 using the trained alteration machine-learning model 172. For the purposes of this disclosure, an “alteration machine-learning model” is a machine-learning model that generates an alteration datum. In some embodiments, alteration training data 176 may be stored in database. In some embodiments, alteration training data 176 may be received from one or more users, database, external computing devices, and/or previous iterations of processing. As a non-limiting example, alteration training data 176 may include instructions from a user, who may be an expert user, a past user in embodiments disclosed herein, or the like, which may be stored in memory and/or stored in database, where the instructions may include labeling of training examples. In some embodiments, alteration training data 176 may be updated iteratively on a feedback loop. As a non-limiting example, processor 104 may update alteration training data 176 iteratively through a feedback loop as a function of primary data 120, secondary data 136, user input 168, or the like. In a non-limiting example, generating alteration machine-learning model 172 may include training, retraining, or fine-tuning alteration machine-learning model 172 using alteration training data 176 or updated alteration training data 176.

With continued reference to FIG. 1, memory 108 contains instructions configuring processor 104 to update one or more discrepant data fields 144 of a plurality of first data fields 116 in first data structure 112 as a function of alteration datum 152. Alteration datum 152 modifies document data 124 of one or more discrepant data fields 144 to conform with secondary data 136 of corresponding data field 148. In a non-limiting example, updating one or more discrepant data fields 144 may include at least one of adding, modifying, or deleting data (e.g., primary data 120, document data 124, and the like) within discrepant data fields 144 of first data structure 112 to conform with secondary data 136 of corresponding data field 148 using alteration datum 152. In another non-limiting example, updating one or more discrepant data fields 144 may include adding missing information or data within discrepant data fields 144 using alteration datum 152. In some embodiments, updating one or more discrepant data fields 144 may include reverting the one or more updated discrepant data fields 144 to a previous state if the one or more updated discrepant data fields 144 does not comply with corresponding data field 148. For the purposes of this disclosure, an “updated discrepant data field” is a discrepant data field that is updated using an alteration datum. In some embodiments, reverting one or more updated discrepant data fields 144 may include comparing the updated discrepant data fields 144 and corresponding data field 148 or comparing updated first data structure 112 (e.g., first data structure 112 that is updated as discrepant data fields 144 are updated) and second data structure 128 and identifying another discrepant data fields 144 within the updated first data structure 112. In some embodiments, processor 104 may generate a user prompt 180 as a function of reverting updated discrepant data fields 144. In some embodiments, processor 104 may update alteration training data 176 as a function of reverting updated discrepant data fields 144 and retrain alteration machine-learning model 172 using the updated alteration training data 176 and regenerate alteration datum 152 using the retrained alteration machine-learning model 172.

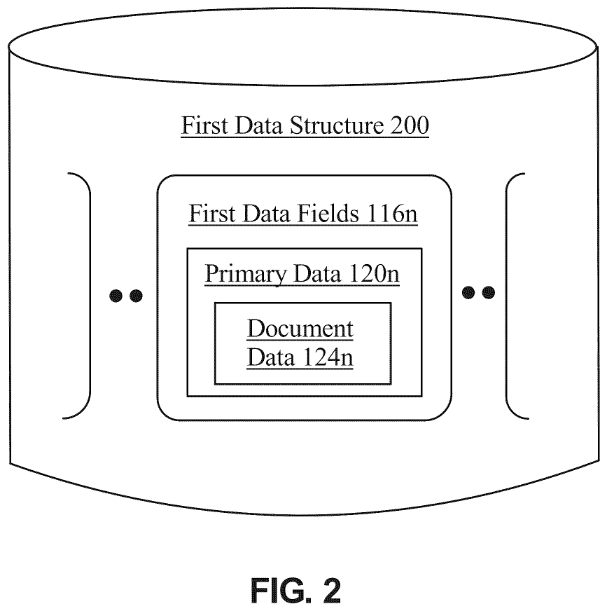

Referring now to FIG. 2, an exemplary first data structure 200 is illustrated. In some embodiments, first data structure 200 may include a database. The first data structure 200 may be consistent with first data structure 112. In some embodiments, first data structure 200 may include a plurality of first data fields 116n, wherein each of the plurality of first data fields 116n may include primary data 120n. In some embodiments, primary data 120n may include document data 124n.

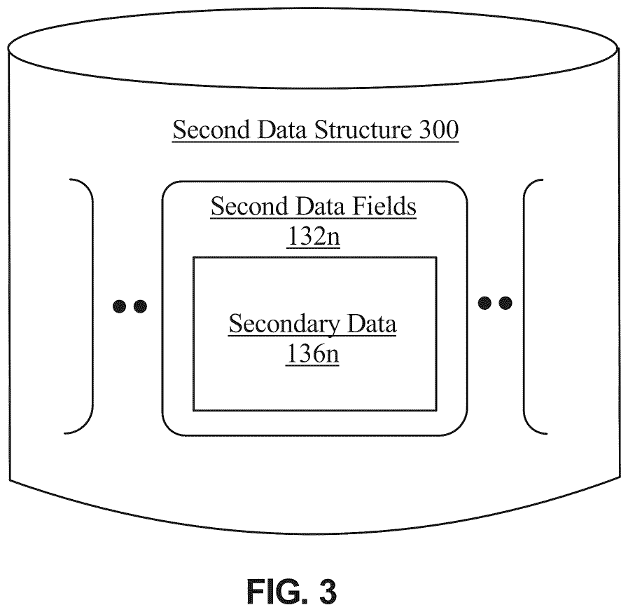

Referring now to FIG. 3, an exemplary second data structure 300 is illustrated. In some embodiments, second data structure 300 may include a database. The second data structure 300 may be consistent with second data structure 128. In some embodiments, second data structure 300 may include a plurality of second data fields 132n, wherein each of the plurality of second data fields 132n may include secondary data 136n.

Referring now to FIG. 4, an exemplary embodiment of a machine-learning module 400 that may perform one or more machine-learning processes as described in this disclosure is illustrated. Machine-learning module may perform determinations, classification, and/or analysis steps, methods, processes, or the like as described in this disclosure using machine learning processes. A “machine learning process,” as used in this disclosure, is a process that automatedly uses training data 404 to generate an algorithm instantiated in hardware or software logic, data structures, and/or functions that will be performed by a computing device/module to produce outputs 408 given data provided as inputs 412; this is in contrast to a non-machine learning software program where the commands to be executed are determined in advance by a user and written in a programming language.

Still referring to FIG. 4, “training data,” as used herein, is data containing correlations that a machine-learning process may use to model relationships between two or more categories of data elements. For instance, and without limitation, training data 404 may include a plurality of data entries, also known as “training examples,” each entry representing a set of data elements that were recorded, received, and/or generated together; data elements may be correlated by shared existence in a given data entry, by proximity in a given data entry, or the like. Multiple data entries in training data 404 may evince one or more trends in correlations between categories of data elements; for instance, and without limitation, a higher value of a first data element belonging to a first category of data element may tend to correlate to a higher value of a second data element belonging to a second category of data element, indicating a possible proportional or other mathematical relationship linking values belonging to the two categories. Multiple categories of data elements may be related in training data 404 according to various correlations; correlations may indicate causative and/or predictive links between categories of data elements, which may be modeled as relationships such as mathematical relationships by machine-learning processes as described in further detail below. Training data 404 may be formatted and/or organized by categories of data elements, for instance by associating data elements with one or more descriptors corresponding to categories of data elements. As a non-limiting example, training data 404 may include data entered in standardized forms by persons or processes, such that entry of a given data element in a given field in a form may be mapped to one or more descriptors of categories. Elements in training data 404 may be linked to descriptors of categories by tags, tokens, or other data elements; for instance, and without limitation, training data 404 may be provided in fixed-length formats, formats linking positions of data to categories such as comma-separated value (CSV) formats and/or self-describing formats such as extensible markup language (XML), JavaScript Object Notation (JSON), or the like, enabling processes or devices to detect categories of data.

Alternatively or additionally, and continuing to refer to FIG. 4, training data 404 may include one or more elements that are not categorized; that is, training data 404 may not be formatted or contain descriptors for some elements of data. Machine-learning algorithms and/or other processes may sort training data 404 according to one or more categorizations using, for instance, natural language processing algorithms, tokenization, detection of correlated values in raw data and the like; categories may be generated using correlation and/or other processing algorithms. As a non-limiting example, in a corpus of text, phrases making up a number “n” of compound words, such as nouns modified by other nouns, may be identified according to a statistically significant prevalence of n-grams containing such words in a particular order; such an n-gram may be categorized as an element of language such as a “word” to be tracked similarly to single words, generating a new category as a result of statistical analysis. Similarly, in a data entry including some textual data, a person's name may be identified by reference to a list, dictionary, or other compendium of terms, permitting ad-hoc categorization by machine-learning algorithms, and/or automated association of data in the data entry with descriptors or into a given format. The ability to categorize data entries automatedly may enable the same training data 404 to be made applicable for two or more distinct machine-learning algorithms as described in further detail below. Training data 404 used by machine-learning module 400 may correlate any input data as described in this disclosure to any output data as described in this disclosure. As a non-limiting illustrative example, input data may include primary data 120, document data 124, secondary data 136, user input 168, and the like. As a non-limiting illustrative example, output data may include alteration datum 152, user prompt XX, correction method datum 156, and the like.

Further referring to FIG. 4, training data may be filtered, sorted, and/or selected using one or more supervised and/or unsupervised machine-learning processes and/or models as described in further detail below; such models may include without limitation a training data classifier 416. Training data classifier 416 may include a “classifier,” which as used in this disclosure is a machine-learning model as defined below, such as a data structure representing and/or using a mathematical model, neural net, or program generated by a machine learning algorithm known as a “classification algorithm,” as described in further detail below, that sorts inputs into categories or bins of data, outputting the categories or bins of data and/or labels associated therewith. A classifier may be configured to output at least a datum that labels or otherwise identifies a set of data that are clustered together, found to be close under a distance metric as described below, or the like. A distance metric may include any norm, such as, without limitation, a Pythagorean norm. Machine-learning module 400 may generate a classifier using a classification algorithm, defined as a processes whereby a computing device and/or any module and/or component operating thereon derives a classifier from training data 404. Classification may be performed using, without limitation, linear classifiers such as without limitation logistic regression and/or naive Bayes classifiers, nearest neighbor classifiers such as k-nearest neighbors classifiers, support vector machines, least squares support vector machines, fisher's linear discriminant, quadratic classifiers, decision trees, boosted trees, random forest classifiers, learning vector quantization, and/or neural network-based classifiers. As a non-limiting example, training data classifier 416 may classify elements of training data to one or more subject cohorts, such as subject's age, gender, medical history, and the like. As another non-limiting example, training data classifier 416 may classify elements of training data to one or more medical professional cohorts, facility cohorts or third party cohorts, such as hospital or organization's location, size, capabilities, availabilities, and the like or health insurance company's location size, capabilities, availabilities, and the like.

Still referring to FIG. 4, computing device may be configured to generate a classifier using a Naïve Bayes classification algorithm. Naïve Bayes classification algorithm generates classifiers by assigning class labels to problem instances, represented as vectors of element values. Class labels are drawn from a finite set. Naïve Bayes classification algorithm may include generating a family of algorithms that assume that the value of a particular element is independent of the value of any other element, given a class variable. Naïve Bayes classification algorithm may be based on Bayes Theorem expressed as P(A/B)=P(B/A) P(A)=P(B), where P (A/B) is the probability of hypothesis A given data B also known as posterior probability; P (B/A) is the probability of data B given that the hypothesis A was true; P(A) is the probability of hypothesis A being true regardless of data also known as prior probability of A; and P(B) is the probability of the data regardless of the hypothesis. A naïve Bayes algorithm may be generated by first transforming training data into a frequency table. Computing device may then calculate a likelihood table by calculating probabilities of different data entries and classification labels. Computing device may utilize a naïve Bayes equation to calculate a posterior probability for each class. A class containing the highest posterior probability is the outcome of prediction. Naïve Bayes classification algorithm may include a gaussian model that follows a normal distribution. Naïve Bayes classification algorithm may include a multinomial model that is used for discrete counts. Naïve Bayes classification algorithm may include a Bernoulli model that may be utilized when vectors are binary.

With continued reference to FIG. 4, Computing device may be configured to generate a classifier using a K-nearest neighbors (KNN) algorithm. A “K-nearest neighbors algorithm” as used in this disclosure, includes a classification method that utilizes feature similarity to analyze how closely out-of-sample-features resemble training data to classify input data to one or more clusters and/or categories of features as represented in training data; this may be performed by representing both training data and input data in vector forms, and using one or more measures of vector similarity to identify classifications within training data, and to determine a classification of input data. K-nearest neighbors algorithm may include specifying a K-value, or a number directing the classifier to select the k most similar entries training data to a given sample, determining the most common classifier of the entries in the database, and classifying the known sample; this may be performed recursively and/or iteratively to generate a classifier that may be used to classify input data as further samples. For instance, an initial set of samples may be performed to cover an initial heuristic and/or “first guess” at an output and/or relationship, which may be seeded, without limitation, using expert input received according to any process as described herein. As a non-limiting example, an initial heuristic may include a ranking of associations between inputs and elements of training data. Heuristic may include selecting some number of highest-ranking associations and/or training data elements.

With continued reference to FIG. 4, generating k-nearest neighbors algorithm may generate a first vector output containing a data entry cluster, generating a second vector output containing an input data, and calculate the distance between the first vector output and the second vector output using any suitable norm such as cosine similarity, Euclidean distance measurement, or the like. Each vector output may be represented, without limitation, as an n-tuple of values, where n is at least two values. Each value of n-tuple of values may represent a measurement or other quantitative value associated with a given category of data, or attribute, examples of which are provided in further detail below; a vector may be represented, without limitation, in n-dimensional space using an axis per category of value represented in n-tuple of values, such that a vector has a geometric direction characterizing the relative quantities of attributes in the n-tuple as compared to each other. Two vectors may be considered equivalent where their directions, and/or the relative quantities of values within each vector as compared to each other, are the same; thus, as a non-limiting example, a vector represented as [5, 10, 15] may be treated as equivalent, for purposes of this disclosure, as a vector represented as [1, 2, 3]. Vectors may be more similar where their directions are more similar, and more different where their directions are more divergent; however, vector similarity may alternatively or additionally be determined using averages of similarities between like attributes, or any other measure of similarity suitable for any n-tuple of values, or aggregation of numerical similarity measures for the purposes of loss functions as described in further detail below. Any vectors as described herein may be scaled, such that each vector represents each attribute along an equivalent scale of values. Each vector may be “normalized,” or divided by a “length” attribute, such as a length attribute [symbol] as derived using a Pythagorean norm:

$$l = \sqrt{{\sum }_{i = 0}^{n} {a}_{i}^{2}} ,$$

where aᵢ is attribute number i of the vector. Scaling and/or normalization may function to make vector comparison independent of absolute quantities of attributes, while preserving any dependency on similarity of attributes; this may, for instance, be advantageous where cases represented in training data are represented by different quantities of samples, which may result in proportionally equivalent vectors with divergent values.

With further reference to FIG. 4, training examples for use as training data may be selected from a population of potential examples according to cohorts relevant to an analytical problem to be solved, a classification task, or the like. Alternatively or additionally, training data may be selected to span a set of likely circumstances or inputs for a machine-learning model and/or process to encounter when deployed. For instance, and without limitation, for each category of input data to a machine-learning process or model that may exist in a range of values in a population of phenomena such as images, user data, process data, physical data, or the like, a computing device, processor, and/or machine-learning model may select training examples representing each possible value on such a range and/or a representative sample of values on such a range. Selection of a representative sample may include selection of training examples in proportions matching a statistically determined and/or predicted distribution of such values according to relative frequency, such that, for instance, values encountered more frequently in a population of data so analyzed are represented by more training examples than values that are encountered less frequently. Alternatively or additionally, a set of training examples may be compared to a collection of representative values in a database and/or presented to a user, so that a process can detect, automatically or via user input, one or more values that are not included in the set of training examples. Computing device, processor, and/or module may automatically generate a missing training example; this may be done by receiving and/or retrieving a missing input and/or output value and correlating the missing input and/or output value with a corresponding output and/or input value collocated in a data record with the retrieved value, provided by a user and/or other device, or the like.

Continuing to refer to FIG. 4, computer, processor, and/or module may be configured to preprocess training data. “Preprocessing” training data, as used in this disclosure, is transforming training data from raw form to a format that can be used for training a machine learning model. Preprocessing may include sanitizing, feature selection, feature scaling, data augmentation and the like.

Still referring to FIG. 4, computer, processor, and/or module may be configured to sanitize training data. “Sanitizing” training data, as used in this disclosure, is a process whereby training examples are removed that interfere with convergence of a machine-learning model and/or process to a useful result. For instance, and without limitation, a training example may include an input and/or output value that is an outlier from typically encountered values, such that a machine-learning algorithm using the training example will be adapted to an unlikely amount as an input and/or output; a value that is more than a threshold number of standard deviations away from an average, mean, or expected value, for instance, may be eliminated. Alternatively or additionally, one or more training examples may be identified as having poor quality data, where “poor quality” is defined as having a signal to noise ratio below a threshold value. Sanitizing may include steps such as removing duplicative or otherwise redundant data, interpolating missing data, correcting data errors, standardizing data, identifying outliers, and the like. In a nonlimiting example, sanitization may include utilizing algorithms for identifying duplicate entries or spell-check algorithms.

As a non-limiting example, and with further reference to FIG. 4, images used to train an image classifier or other machine-learning model and/or process that takes images as inputs or generates images as outputs may be rejected if image quality is below a threshold value. For instance, and without limitation, computing device, processor, and/or module may perform blur detection, and eliminate one or more Blur detection may be performed, as a non-limiting example, by taking Fourier transform, or an approximation such as a Fast Fourier Transform (FFT) of the image and analyzing a distribution of low and high frequencies in the resulting frequency-domain depiction of the image; numbers of high-frequency values below a threshold level may indicate blurriness. As a further non-limiting example, detection of blurriness may be performed by convolving an image, a channel of an image, or the like with a Laplacian kernel; this may generate a numerical score reflecting a number of rapid changes in intensity shown in the image, such that a high score indicates clarity and a low score indicates blurriness. Blurriness detection may be performed using a gradient-based operator, which measures operators based on the gradient or first derivative of an image, based on the hypothesis that rapid changes indicate sharp edges in the image, and thus are indicative of a lower degree of blurriness. Blur detection may be performed using Wavelet-based operator, which takes advantage of the capability of coefficients of the discrete wavelet transform to describe the frequency and spatial content of images. Blur detection may be performed using statistics-based operators take advantage of several image statistics as texture descriptors in order to compute a focus level. Blur detection may be performed by using discrete cosine transform (DCT) coefficients in order to compute a focus level of an image from its frequency content.

Continuing to refer to FIG. 4, computing device, processor, and/or module may be configured to precondition one or more training examples. For instance, and without limitation, where a machine learning model and/or process has one or more inputs and/or outputs requiring, transmitting, or receiving a certain number of bits, samples, or other units of data, one or more training examples' elements to be used as or compared to inputs and/or outputs may be modified to have such a number of units of data. For instance, a computing device, processor, and/or module may convert a smaller number of units, such as in a low pixel count image, into a desired number of units, for instance by upsampling and interpolating. As a non-limiting example, a low pixel count image may have 100 pixels, however a desired number of pixels may be 128. Processor may interpolate the low pixel count image to convert the 100 pixels into 128 pixels. It should also be noted that one of ordinary skill in the art, upon reading this disclosure, would know the various methods to interpolate a smaller number of data units such as samples, pixels, bits, or the like to a desired number of such units. In some instances, a set of interpolation rules may be trained by sets of highly detailed inputs and/or outputs and corresponding inputs and/or outputs downsampled to smaller numbers of units, and a neural network or other machine learning model that is trained to predict interpolated pixel values using the training data. As a non-limiting example, a sample input and/or output, such as a sample picture, with sample-expanded data units (e.g., pixels added between the original pixels) may be input to a neural network or machine-learning model and output a pseudo replica sample-picture with dummy values assigned to pixels between the original pixels based on a set of interpolation rules. As a non-limiting example, in the context of an image classifier, a machine-learning model may have a set of interpolation rules trained by sets of highly detailed images and images that have been downsampled to smaller numbers of pixels, and a neural network or other machine learning model that is trained using those examples to predict interpolated pixel values in a facial picture context. As a result, an input with sample-expanded data units (the ones added between the original data units, with dummy values) may be run through a trained neural network and/or model, which may fill in values to replace the dummy values. Alternatively or additionally, processor, computing device, and/or module may utilize sample expander methods, a low-pass filter, or both. As used in this disclosure, a “low-pass filter” is a filter that passes signals with a frequency lower than a selected cutoff frequency and attenuates signals with frequencies higher than the cutoff frequency. The exact frequency response of the filter depends on the filter design. Computing device, processor, and/or module may use averaging, such as luma or chroma averaging in images, to fill in data units in between original data units.

In some embodiments, and with continued reference to FIG. 4, computing device, processor, and/or module may down-sample elements of a training example to a desired lower number of data elements. As a non-limiting example, a high pixel count image may have 256 pixels, however a desired number of pixels may be 128. Processor may down-sample the high pixel count image to convert the 256 pixels into 128 pixels. In some embodiments, processor may be configured to perform downsampling on data. Downsampling, also known as decimation, may include removing every Nth entry in a sequence of samples, all but every Nth entry, or the like, which is a process known as “compression,” and may be performed, for instance by an N-sample compressor implemented using hardware or software. Anti-aliasing and/or anti-imaging filters, and/or low-pass filters, may be used to clean up side-effects of compression.

Further referring to FIG. 4, feature selection includes narrowing and/or filtering training data to exclude features and/or elements, or training data including such elements, that are not relevant to a purpose for which a trained machine-learning model and/or algorithm is being trained, and/or collection of features and/or elements, or training data including such elements, on the basis of relevance or utility for an intended task or purpose for a trained machine-learning model and/or algorithm is being trained. Feature selection may be implemented, without limitation, using any process described in this disclosure, including without limitation using training data classifiers, exclusion of outliers, or the like.

With continued reference to FIG. 4, feature scaling may include, without limitation, normalization of data entries, which may be accomplished by dividing numerical fields by norms thereof, for instance as performed for vector normalization. Feature scaling may include absolute maximum scaling, wherein each quantitative datum is divided by the maximum absolute value of all quantitative data of a set or subset of quantitative data. Feature scaling may include min-max scaling, in which each value X has a minimum value Xₘᵢₙ in a set or subset of values subtracted therefrom, with the result divided by the range of the values, give maximum value in the set or subset

$${X}_{m ax} : {X}_{n e w} = \frac{X - {X}_{m i n}}{{X}_{m ax} - {X}_{m i n}} .$$

Feature scaling may include mean normalization, which involves use of a mean value of a set and/or subset of values, Xₘₑₐₙ with maximum and minimum values:

$${X}_{n e w} = \frac{X - {X}_{mean}}{{X}_{m ax} - {X}_{m i n}} .$$

Feature scaling may include standardization, where a difference between X and Xₘₑₐₙ is divided by a standard deviation σ of a set or subset of values:

$${X}_{n e w} = \frac{X - {X}_{mean}}{σ} .$$

Scaling may be performed using a median value of a set or subset X_{median} and/or interquartile range (IQR), which represents the difference between the 25^{th} percentile value and the 50^{th} percentile value (or closest values thereto by a rounding protocol), such as:

$${X}_{n e w} = \frac{X - {X}_{median}}{IQR} .$$

Persons skilled in the art, upon reviewing the entirety of this disclosure, will be aware of various alternative or additional approaches that may be used for feature scaling.

Further referring to FIG. 4, computing device, processor, and/or module may be configured to perform one or more processes of data augmentation. “Data augmentation” as used in this disclosure is addition of data to a training set using elements and/or entries already in the dataset. Data augmentation may be accomplished, without limitation, using interpolation, generation of modified copies of existing entries and/or examples, and/or one or more generative AI processes, for instance using deep neural networks and/or generative adversarial networks; generative processes may be referred to alternatively in this context as “data synthesis” and as creating “synthetic data.” Augmentation may include performing one or more transformations on data, such as geometric, color space, affine, brightness, cropping, and/or contrast transformations of images.

Still referring to FIG. 4, machine-learning module 400 may be configured to perform a lazy-learning process 420 and/or protocol, which may alternatively be referred to as a “lazy loading” or “call-when-needed” process and/or protocol, may be a process whereby machine learning is conducted upon receipt of an input to be converted to an output, by combining the input and training set to derive the algorithm to be used to produce the output on demand. For instance, an initial set of simulations may be performed to cover an initial heuristic and/or “first guess” at an output and/or relationship. As a non-limiting example, an initial heuristic may include a ranking of associations between inputs and elements of training data 404. Heuristic may include selecting some number of highest-ranking associations and/or training data 404 elements. Lazy learning may implement any suitable lazy learning algorithm, including without limitation a K-nearest neighbors algorithm, a lazy naïve Bayes algorithm, or the like; persons skilled in the art, upon reviewing the entirety of this disclosure, will be aware of various lazy-learning algorithms that may be applied to generate outputs as described in this disclosure, including without limitation lazy learning applications of machine-learning algorithms as described in further detail below.

Alternatively or additionally, and with continued reference to FIG. 4, machine-learning processes as described in this disclosure may be used to generate machine-learning models 424. A “machine-learning model,” as used in this disclosure, is a data structure representing and/or instantiating a mathematical and/or algorithmic representation of a relationship between inputs and outputs, as generated using any machine-learning process including without limitation any process as described above, and stored in memory; an input is submitted to a machine-learning model 424 once created, which generates an output based on the relationship that was derived. For instance, and without limitation, a linear regression model, generated using a linear regression algorithm, may compute a linear combination of input data using coefficients derived during machine-learning processes to calculate an output datum. As a further non-limiting example, a machine-learning model 424 may be generated by creating an artificial neural network, such as a convolutional neural network comprising an input layer of nodes, one or more intermediate layers, and an output layer of nodes. Connections between nodes may be created via the process of “training” the network, in which elements from a training data 404 set are applied to the input nodes, a suitable training algorithm (such as Levenberg-Marquardt, conjugate gradient, simulated annealing, or other algorithms) is then used to adjust the connections and weights between nodes in adjacent layers of the neural network to produce the desired values at the output nodes. This process is sometimes referred to as deep learning.

Still referring to FIG. 4, machine-learning algorithms may include at least a supervised machine-learning process 428. At least a supervised machine-learning process 428, as defined herein, include algorithms that receive a training set relating a number of inputs to a number of outputs, and seek to generate one or more data structures representing and/or instantiating one or more mathematical relations relating inputs to outputs, where each of the one or more mathematical relations is optimal according to some criterion specified to the algorithm using some scoring function. For instance, a supervised learning algorithm may include primary data 120, document data 124, secondary data 136, user input 168, and the like as described above as inputs, alteration datum 152, user prompt XX, correction method datum 156, and the like as outputs, and a scoring function representing a desired form of relationship to be detected between inputs and outputs; scoring function may, for instance, seek to maximize the probability that a given input and/or combination of elements inputs is associated with a given output to minimize the probability that a given input is not associated with a given output. Scoring function may be expressed as a risk function representing an “expected loss” of an algorithm relating inputs to outputs, where loss is computed as an error function representing a degree to which a prediction generated by the relation is incorrect when compared to a given input-output pair provided in training data 404. Persons skilled in the art, upon reviewing the entirety of this disclosure, will be aware of various possible variations of at least a supervised machine-learning process 428 that may be used to determine relation between inputs and outputs. Supervised machine-learning processes may include classification algorithms as defined above.

With further reference to FIG. 4, training a supervised machine-learning process may include, without limitation, iteratively updating coefficients, biases, weights based on an error function, expected loss, and/or risk function. For instance, an output generated by a supervised machine-learning model using an input example in a training example may be compared to an output example from the training example; an error function may be generated based on the comparison, which may include any error function suitable for use with any machine-learning algorithm described in this disclosure, including a square of a difference between one or more sets of compared values or the like. Such an error function may be used in turn to update one or more weights, biases, coefficients, or other parameters of a machine-learning model through any suitable process including without limitation gradient descent processes, least-squares processes, and/or other processes described in this disclosure. This may be done iteratively and/or recursively to gradually tune such weights, biases, coefficients, or other parameters. Updating may be performed, in neural networks, using one or more back-propagation algorithms. Iterative and/or recursive updates to weights, biases, coefficients, or other parameters as described above may be performed until currently available training data is exhausted and/or until a convergence test is passed, where a “convergence test” is a test for a condition selected as indicating that a model and/or weights, biases, coefficients, or other parameters thereof has reached a degree of accuracy. A convergence test may, for instance, compare a difference between two or more successive errors or error function values, where differences below a threshold amount may be taken to indicate convergence. Alternatively or additionally, one or more errors and/or error function values evaluated in training iterations may be compared to a threshold.

Still referring to FIG. 4, a computing device, processor, and/or module may be configured to perform method, method step, sequence of method steps and/or algorithm described in reference to this figure, in any order and with any degree of repetition. For instance, a computing device, processor, and/or module may be configured to perform a single step, sequence and/or algorithm repeatedly until a desired or commanded outcome is achieved; repetition of a step or a sequence of steps may be performed iteratively and/or recursively using outputs of previous repetitions as inputs to subsequent repetitions, aggregating inputs and/or outputs of repetitions to produce an aggregate result, reduction or decrement of one or more variables such as global variables, and/or division of a larger processing task into a set of iteratively addressed smaller processing tasks. A computing device, processor, and/or module may perform any step, sequence of steps, or algorithm in parallel, such as simultaneously and/or substantially simultaneously performing a step two or more times using two or more parallel threads, processor cores, or the like; division of tasks between parallel threads and/or processes may be performed according to any protocol suitable for division of tasks between iterations. Persons skilled in the art, upon reviewing the entirety of this disclosure, will be aware of various ways in which steps, sequences of steps, processing tasks, and/or data may be subdivided, shared, or otherwise dealt with using iteration, recursion, and/or parallel processing.

Further referring to FIG. 4, machine learning processes may include at least an unsupervised machine-learning processes 432. An unsupervised machine-learning process, as used herein, is a process that derives inferences in datasets without regard to labels; as a result, an unsupervised machine-learning process may be free to discover any structure, relationship, and/or correlation provided in the data. Unsupervised processes 432 may not require a response variable; unsupervised processes 432 may be used to find interesting patterns and/or inferences between variables, to determine a degree of correlation between two or more variables, or the like.

Still referring to FIG. 4, machine-learning module 400 may be designed and configured to create a machine-learning model 424 using techniques for development of linear regression models. Linear regression models may include ordinary least squares regression, which aims to minimize the square of the difference between predicted outcomes and actual outcomes according to an appropriate norm for measuring such a difference (e.g. a vector-space distance norm); coefficients of the resulting linear equation may be modified to improve minimization. Linear regression models may include ridge regression methods, where the function to be minimized includes the least-squares function plus term multiplying the square of each coefficient by a scalar amount to penalize large coefficients. Linear regression models may include least absolute shrinkage and selection operator (LASSO) models, in which ridge regression is combined with multiplying the least-squares term by a factor of 1 divided by double the number of samples. Linear regression models may include a multi-task lasso model wherein the norm applied in the least-squares term of the lasso model is the Frobenius norm amounting to the square root of the sum of squares of all terms. Linear regression models may include the clastic net model, a multi-task elastic net model, a least angle regression model, a LARS lasso model, an orthogonal matching pursuit model, a Bayesian regression model, a logistic regression model, a stochastic gradient descent model, a perceptron model, a passive aggressive algorithm, a robustness regression model, a Huber regression model, or any other suitable model that may occur to persons skilled in the art upon reviewing the entirety of this disclosure. Linear regression models may be generalized in an embodiment to polynomial regression models, whereby a polynomial equation (e.g. a quadratic, cubic or higher-order equation) providing a best predicted output/actual output fit is sought; similar methods to those described above may be applied to minimize error functions, as will be apparent to persons skilled in the art upon reviewing the entirety of this disclosure.

Continuing to refer to FIG. 4, machine-learning algorithms may include, without limitation, linear discriminant analysis. Machine-learning algorithm may include quadratic discriminant analysis. Machine-learning algorithms may include kernel ridge regression. Machine-learning algorithms may include support vector machines, including without limitation support vector classification-based regression processes. Machine-learning algorithms may include stochastic gradient descent algorithms, including classification and regression algorithms based on stochastic gradient descent. Machine-learning algorithms may include nearest neighbors algorithms. Machine-learning algorithms may include various forms of latent space regularization such as variational regularization. Machine-learning algorithms may include Gaussian processes such as Gaussian Process Regression. Machine-learning algorithms may include cross-decomposition algorithms, including partial least squares and/or canonical correlation analysis. Machine-learning algorithms may include naïve Bayes methods. Machine-learning algorithms may include algorithms based on decision trees, such as decision tree classification or regression algorithms. Machine-learning algorithms may include ensemble methods such as bagging meta-estimator, forest of randomized trees, AdaBoost, gradient tree boosting, and/or voting classifier methods. Machine-learning algorithms may include neural net algorithms, including convolutional neural net processes.

Still referring to FIG. 4, a machine-learning model and/or process may be deployed or instantiated by incorporation into a program, apparatus, system and/or module. For instance, and without limitation, a machine-learning model, neural network, and/or some or all parameters thereof may be stored and/or deployed in any memory or circuitry. Parameters such as coefficients, weights, and/or biases may be stored as circuit-based constants, such as arrays of wires and/or binary inputs and/or outputs set at logic “1” and “0” voltage levels in a logic circuit to represent a number according to any suitable encoding system including twos complement or the like or may be stored in any volatile and/or non-volatile memory. Similarly, mathematical operations and input and/or output of data to or from models, neural network layers, or the like may be instantiated in hardware circuitry and/or in the form of instructions in firmware, machine-code such as binary operation code instructions, assembly language, or any higher-order programming language. Any technology for hardware and/or software instantiation of memory, instructions, data structures, and/or algorithms may be used to instantiate a machine-learning process and/or model, including without limitation any combination of production and/or configuration of non-reconfigurable hardware elements, circuits, and/or modules such as without limitation ASICs, production and/or configuration of reconfigurable hardware elements, circuits, and/or modules such as without limitation FPGAs, production and/or of non-reconfigurable and/or configuration non-rewritable memory elements, circuits, and/or modules such as without limitation non-rewritable ROM, production and/or configuration of reconfigurable and/or rewritable memory elements, circuits, and/or modules such as without limitation rewritable ROM or other memory technology described in this disclosure, and/or production and/or configuration of any computing device and/or component thereof as described in this disclosure. Such deployed and/or instantiated machine-learning model and/or algorithm may receive inputs from any other process, module, and/or component described in this disclosure, and produce outputs to any other process, module, and/or component described in this disclosure.

Continuing to refer to FIG. 4, any process of training, retraining, deployment, and/or instantiation of any machine-learning model and/or algorithm may be performed and/or repeated after an initial deployment and/or instantiation to correct, refine, and/or improve the machine-learning model and/or algorithm. Such retraining, deployment, and/or instantiation may be performed as a periodic or regular process, such as retraining, deployment, and/or instantiation at regular elapsed time periods, after some measure of volume such as a number of bytes or other measures of data processed, a number of uses or performances of processes described in this disclosure, or the like, and/or according to a software, firmware, or other update schedule. Alternatively or additionally, retraining, deployment, and/or instantiation may be event-based, and may be triggered, without limitation, by user inputs indicating sub-optimal or otherwise problematic performance and/or by automated field testing and/or auditing processes, which may compare outputs of machine-learning models and/or algorithms, and/or errors and/or error functions thereof, to any thresholds, convergence tests, or the like, and/or may compare outputs of processes described herein to similar thresholds, convergence tests or the like. Event-based retraining, deployment, and/or instantiation may alternatively or additionally be triggered by receipt and/or generation of one or more new training examples; a number of new training examples may be compared to a preconfigured threshold, where exceeding the preconfigured threshold may trigger retraining, deployment, and/or instantiation.

Still referring to FIG. 4, retraining and/or additional training may be performed using any process for training described above, using any currently or previously deployed version of a machine-learning model and/or algorithm as a starting point. Training data for retraining may be collected, preconditioned, sorted, classified, sanitized or otherwise processed according to any process described in this disclosure. Training data may include, without limitation, training examples including inputs and correlated outputs used, received, and/or generated from any version of any system, module, machine-learning model or algorithm, apparatus, and/or method described in this disclosure; such examples may be modified and/or labeled according to user feedback or other processes to indicate desired results, and/or may have actual or measured results from a process being modeled and/or predicted by system, module, machine-learning model or algorithm, apparatus, and/or method as “desired” results to be compared to outputs for training processes as described above.

Redeployment may be performed using any reconfiguring and/or rewriting of reconfigurable and/or rewritable circuit and/or memory elements; alternatively, redeployment may be performed by production of new hardware and/or software components, circuits, instructions, or the like, which may be added to and/or may replace existing hardware and/or software components, circuits, instructions, or the like.

Further referring to FIG. 4, one or more processes or algorithms described above may be performed by at least a dedicated hardware unit 436. A “dedicated hardware unit,” for the purposes of this figure, is a hardware component, circuit, or the like, aside from a principal control circuit and/or processor performing method steps as described in this disclosure, that is specifically designated or selected to perform one or more specific tasks and/or processes described in reference to this figure, such as without limitation preconditioning and/or sanitization of training data and/or training a machine-learning algorithm and/or model. A dedicated hardware unit 436 may include, without limitation, a hardware unit that can perform iterative or massed calculations, such as matrix-based calculations to update or tune parameters, weights, coefficients, and/or biases of machine-learning models and/or neural networks, efficiently using pipelining, parallel processing, or the like; such a hardware unit may be optimized for such processes by, for instance, including dedicated circuitry for matrix and/or signal processing operations that includes, e.g., multiple arithmetic and/or logical circuit units such as multipliers and/or adders that can act simultaneously and/or in parallel or the like. Such dedicated hardware units 436 may include, without limitation, graphical processing units (GPUs), dedicated signal processing modules, FPGA or other reconfigurable hardware that has been configured to instantiate parallel processing units for one or more specific tasks, or the like, A computing device, processor, apparatus, or module may be configured to instruct one or more dedicated hardware units 436 to perform one or more operations described herein, such as evaluation of model and/or algorithm outputs, one-time or iterative updates to parameters, coefficients, weights, and/or biases, and/or any other operations such as vector and/or matrix operations as described in this disclosure.

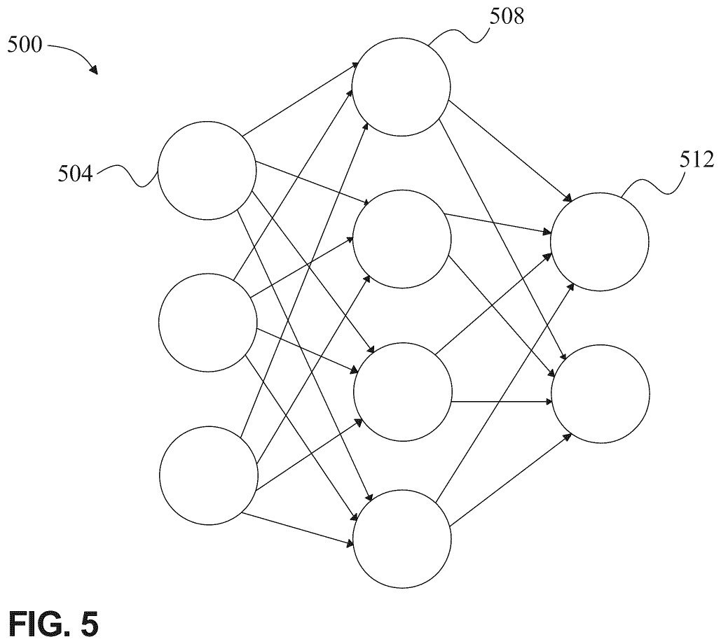

Referring now to FIG. 5 an exemplary embodiment of neural network 500 is illustrated. A neural network 500 also known as an artificial neural network, is a network of “nodes,” or data structures having one or more inputs, one or more outputs, and a function determining outputs based on inputs. Such nodes may be organized in a network, such as without limitation a convolutional neural network, including an input layer of nodes 504, one or more intermediate layers 508, and an output layer of nodes 512. Connections between nodes may be created via the process of “training” the network, in which elements from a training dataset are applied to the input nodes, a suitable training algorithm (such as Levenberg-Marquardt, conjugate gradient, simulated annealing, or other algorithms) is then used to adjust the connections and weights between nodes in adjacent layers of the neural network to produce the desired values at the output nodes. This process is sometimes referred to as deep learning. Connections may run solely from input nodes toward output nodes in a “feed-forward” network, or may feed outputs of one layer back to inputs of the same or a different layer in a “recurrent network.” As a further non-limiting example, a neural network may include a convolutional neural network comprising an input layer of nodes, one or more intermediate layers, and an output layer of nodes. A “convolutional neural network,” as used in this disclosure, is a neural network in which at least one hidden layer is a convolutional layer that convolves inputs to that layer with a subset of inputs known as a “kernel,” along with one or more additional layers such as pooling layers, fully connected layers, and the like.

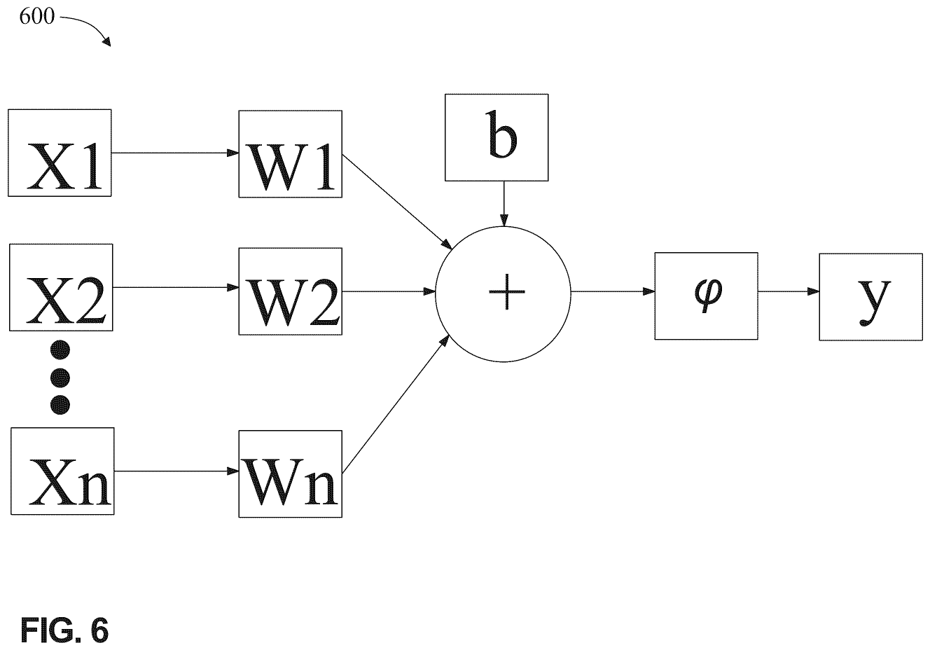

Referring now to FIG. 6, an exemplary embodiment of a node 600 of a neural network is illustrated. A node may include, without limitation a plurality of inputs xᵢ that may receive numerical values from inputs to a neural network containing the node and/or from other nodes. Node may perform one or more activation functions to produce its output given one or more inputs, such as without limitation computing a binary step function comparing an input to a threshold value and outputting either a logic 1 or logic 0 output or something equivalent, a linear activation function whereby an output is directly proportional to the input, and/or a non-linear activation function, wherein the output is not proportional to the input. Non-linear activation functions may include, without limitation, a sigmoid function of the form

$$f ( x ) = \frac{1}{1 - {e}^{- x}}$$

given input x, a tanh (hyperbolic tangent) function, of the form

$$\frac{{e}^{x} - {e}^{- x}}{{e}^{x} + {e}^{- x}} ,$$

a tanh derivative function such as ƒ(x)=tanh²(x), a rectified linear unit function such as ƒ(x)=max (0, x), a “leaky” and/or “parametric” rectified linear unit function such as ƒ(x)=max (αx, x) for some α, an exponential linear units function such as

$$f ( x ) = \{ \begin{matrix}x for x \geq 0 \\ α ( {e}^{x} - 1 ) for x < 0\end{matrix}$$

for some value of α (this function may be replaced and/or weighted by its own derivative in some embodiments), a softmax function such as

$$f ( {x}_{i} ) = \frac{{e}^{x}}{{\sum }_{i} {x}_{i}}$$

where the inputs to an instant layer are xᵢ, a swish function such as ƒ(x)=x*sigmoid(x), a Gaussian error linear unit function such as ƒ(x)=a (1+tanh (\sqrt{2/π}(x+bx^{r}))) for some values of a, b, and r, and/or a scaled exponential linear unit function such as

$$f ( x ) = λ \{ \begin{matrix}α ( {e}^{x} - 1 ) for x < 0 \\ x for x \geq 0\end{matrix} .$$

Fundamentally, there is no limit to the nature of functions of inputs xᵢ that may be used as activation functions. As a non-limiting and illustrative example, node may perform a weighted sum of inputs using weights wᵢ that are multiplied by respective inputs xᵢ. Additionally or alternatively, a bias b may be added to the weighted sum of the inputs such that an offset is added to each unit in the neural network layer that is independent of the input to the layer. The weighted sum may then be input into a function φ, which may generate one or more outputs y. Weight wᵢ applied to an input xᵢ may indicate whether the input is “excitatory,” indicating that it has strong influence on the one or more outputs y, for instance by the corresponding weight having a large numerical value, and/or a “inhibitory,” indicating it has a weak effect influence on the one more inputs y, for instance by the corresponding weight having a small numerical value. The values of weights wᵢ may be determined by training a neural network using training data, which may be performed using any suitable process as described above.

Referring to FIG. 7, an exemplary embodiment of fuzzy set comparison 700 is illustrated. A first fuzzy set 704 may be represented, without limitation, according to a first membership function 708 representing a probability that an input falling on a first range of values 712 is a member of the first fuzzy set 704, where the first membership function 708 has values on a range of probabilities such as without limitation the interval [0,1], and an area beneath the first membership function 708 may represent a set of values within first fuzzy set 704. Although first range of values 712 is illustrated for clarity in this exemplary depiction as a range on a single number line or axis, first range of values 712 may be defined on two or more dimensions, representing, for instance, a Cartesian product between a plurality of ranges, curves, axes, spaces, dimensions, or the like. First membership function 708 may include any suitable function mapping first range 712 to a probability interval, including without limitation a triangular function defined by two linear elements such as line segments or planes that intersect at or below the top of the probability interval. As a non-limiting example, triangular membership function may be defined as:

$$y ( x , a , b , c ) = \{ \begin{matrix}0 , for x > c and x < a \\ \frac{x - a}{b - a} , for a \leq x < b \\ \frac{c - x}{c - b} , if b < x \leq c\end{matrix}$$

a trapezoidal membership function may be defined as:

$$y ( x , a , b , c , d ) = max ( min ( \frac{x - a}{b - a} , 1 , \frac{d - x}{d - c} ) , 0 )$$

a sigmoidal function may be defined as:

$$y ( x , a , c ) = \frac{1}{1 - {e}^{- a ( x - c )}}$$

a Gaussian membership function may be defined as:

$$y ( x , c , σ ) = {e}^{- \frac{1}{2} {( \frac{x - c}{σ} )}^{2}}$$

and a bell membership function may be defined as:

$$y ( x , a , b , c , ) = {[ 1 + {\vert \frac{x - c}{a} \vert}^{2 b} ]}^{- 1}$$

Persons skilled in the art, upon reviewing the entirety of this disclosure, will be aware of various alternative or additional membership functions that may be used consistently with this disclosure.

Still referring to FIG. 7, first fuzzy set 704 may represent any value or combination of values as described above, including output from one or more machine-learning models, primary data 120 and secondary data 136, and a predetermined class, such as without limitation of discrepancy (e.g., discrepant data field 144). A second fuzzy set 716, which may represent any value which may be represented by first fuzzy set 704, may be defined by a second membership function 720 on a second range 724; second range 724 may be identical and/or overlap with first range 712 and/or may be combined with first range via Cartesian product or the like to generate a mapping permitting evaluation overlap of first fuzzy set 704 and second fuzzy set 716. Where first fuzzy set 704 and second fuzzy set 716 have a region 728 that overlaps, first membership function 708 and second membership function 720 may intersect at a point 732 representing a probability, as defined on probability interval, of a match between first fuzzy set 704 and second fuzzy set 716. Alternatively or additionally, a single value of first and/or second fuzzy set may be located at a locus 736 on first range 712 and/or second range 724, where a probability of membership may be taken by evaluation of first membership function 708 and/or second membership function 720 at that range point. A probability at 728 and/or 732 may be compared to a threshold 740 to determine whether a positive match is indicated. Threshold 740 may, in a non-limiting example, represent a degree of match between first fuzzy set 704 and second fuzzy set 716, and/or single values therein with each other or with either set, which is sufficient for purposes of the matching process; for instance, threshold may indicate a sufficient degree of overlap between an output from one or more machine-learning models and/or primary data 120 and secondary data 136 and a predetermined class, such as without limitation discrepancy categorization, for combination to occur as described above. Alternatively or additionally, each threshold may be tuned by a machine-learning and/or statistical process, for instance and without limitation as described in further detail below.

Further referring to FIG. 7, in an embodiment, a degree of match between fuzzy sets may be used to classify primary data 120 and secondary data 136 with discrepancy. For instance, if a discrepancy has a fuzzy set matching primary data and secondary data fuzzy set by having a degree of overlap exceeding a threshold, processor 104 may classify the primary data 120 and secondary data 136 as belonging to the discrepancy categorization. Where multiple fuzzy matches are performed, degrees of match for each respective fuzzy set may be computed and aggregated through, for instance, addition, averaging, or the like, to determine an overall degree of match.

Still referring to FIG. 7, in an embodiment, primary data 120 and secondary data 136 may be compared to multiple discrepancy categorization fuzzy sets. For instance, primary data 120 and secondary data 136 may be represented by a fuzzy set that is compared to each of the multiple discrepancy categorization fuzzy sets; and a degree of overlap exceeding a threshold between the primary data and secondary data fuzzy set and any of the multiple discrepancy categorization fuzzy sets may cause processor 104 to classify the primary data 120 and secondary data 136 as belonging to discrepancy categorization. For instance, in one embodiment there may be two discrepancy categorization fuzzy sets, representing respectively discrepant categorization and non-discrepant categorization. First discrepancy categorization may have a first fuzzy set; Second discrepancy categorization may have a second fuzzy set; and primary data 120 and secondary data 136 may have primary data and secondary data fuzzy set. processor 104, for example, may compare primary data and secondary data fuzzy set with each of discrepancy categorization fuzzy set and non-discrepancy categorization fuzzy set, as described above, and classify a primary data 120 and secondary data 136 to either, both, or neither of discrepancy categorization or non-discrepancy categorization. Machine-learning methods as described throughout may, in a non-limiting example, generate coefficients used in fuzzy set equations as described above, such as without limitation x, c, and σ of a Gaussian set as described above, as outputs of machine-learning methods. Likewise, primary data 120 and secondary data 136 may be used indirectly to determine a fuzzy set, as primary data and secondary data fuzzy set may be derived from outputs of one or more machine-learning models that take the primary data 120 and secondary data 136 directly or indirectly as inputs.

Still referring to FIG. 7, a computing device may use a logic comparison program, such as, but not limited to, a fuzzy logic model to determine a discrepancy response. A discrepancy response may include, but is not limited to, discrepant or non-discrepant, and the like; each such discrepancy response may be represented as a value for a linguistic variable representing discrepancy response or in other words a fuzzy set as described above that corresponds to a degree of discrepancy as calculated using any statistical, machine-learning, or other method that may occur to a person skilled in the art upon reviewing the entirety of this disclosure. In other words, a given element of primary data 120 and secondary data 136 may have a first non-zero value for membership in a first linguistic variable value such as “discrepant” and a second non-zero value for membership in a second linguistic variable value such as “non-discrepant.” In some embodiments, determining a discrepancy categorization may include using a linear regression model. A linear regression model may include a machine learning model. A linear regression model may be configured to map data of primary data 120 and secondary data 136, such as degree of discrepancy to one or more discrepancy parameters. A linear regression model may be trained using a machine learning process. A linear regression model may map statistics such as, but not limited to, quality of primary data 120 and secondary data 136 discrepancy. In some embodiments, determining discrepancy of primary data 120 and secondary data 136 may include using a discrepancy classification model. Discrepancy classification model may be configured to input collected data and cluster data to a centroid based on, but not limited to, frequency of appearance, linguistic indicators of quality, and the like. Centroids may include scores assigned to them such that quality of discrepancy of primary data 120 and secondary data 136 may each be assigned a score. In some embodiments discrepancy classification model may include a K-means clustering model. In some embodiments, discrepancy classification model may include a particle swarm optimization model. In some embodiments, determining the discrepancy of primary data 120 and secondary data 136 may include using a fuzzy inference engine. A fuzzy inference engine may be configured to map one or more primary data 120 and secondary data 136 data elements using fuzzy logic. In some embodiments, primary data 120 and secondary data 136 may be arranged by a logic comparison program into discrepancy arrangement. An “data arrangement” as used in this disclosure is any grouping of objects and/or data based on discrepancy level and/or discrepancy score. This step may be implemented as described above in FIGS. 1-6. Membership function coefficients and/or constants as described above may be tuned according to classification and/or clustering algorithms. For instance, and without limitation, a clustering algorithm may determine a Gaussian or other distribution of questions about a centroid corresponding to a given discrepancy level, and an iterative or other method may be used to find a membership function, for any membership function type as described above, that minimizes an average error from the statistically determined distribution, such that, for instance, a triangular or Gaussian membership function about a centroid representing a center of the distribution that most closely matches the distribution. Error functions to be minimized, and/or methods of minimization, may be performed without limitation according to any error function and/or error function minimization process and/or method as described in this disclosure.

Further referring to FIG. 7, an inference engine may be implemented according to input and/or output membership functions and/or linguistic variables. For instance, a first linguistic variable may represent a first measurable value pertaining to primary data 120 and secondary data 136, such as a degree of discrepancy of an element, while a second membership function may indicate a degree of in discrepancy of a subject thereof, or another measurable value pertaining to primary data 120 and secondary data 136. Continuing the example, an output linguistic variable may represent, without limitation, a score value. An inference engine may combine rules, the degree to which a given input function membership matches a given rule may be determined by a triangular norm or “T-norm” of the rule or output membership function with the input membership function, such as min (a, b), product of a and b, drastic product of a and b, Hamacher product of a and b, or the like, satisfying the rules of commutativity (T(a, b)=T(b, a)), monotonicity: (T(a, b)≤T(c, d) if a≤c and b≤d), (associativity: T(a, T(b, c))=T(T(a, b), c)), and the requirement that the number 1 acts as an identity element. Combinations of rules (“and” or “or” combination of rule membership determinations) may be performed using any T-conorm, as represented by an inverted T symbol or “⊥,” such as max (a, b), probabilistic sum of a and b (a+b−a*b), bounded sum, and/or drastic T-conorm; any T-conorm may be used that satisfies the properties of commutativity: ⊥(a, b)=⊥(b, a), monotonicity: ⊥(a, b)≤⊥(c, d) if a≤c and b≤d, associativity: ⊥(a, ⊥(b, c))=⊥(⊥(a, b), c), and identity element of 0. Alternatively or additionally T-conorm may be approximated by sum, as in a “product-sum” inference engine in which T-norm is product and T-conorm is sum. A final output score or other fuzzy inference output may be determined from an output membership function as described above using any suitable defuzzification process, including without limitation Mean of Max defuzzification, Centroid of Area/Center of Gravity defuzzification, Center Average defuzzification, Bisector of Arca defuzzification, or the like. Alternatively or additionally, output rules may be replaced with functions according to the Takagi-Sugeno-King (TSK) fuzzy model.

Further referring to FIG. 7, primary data 120 and secondary data 136 to be used may be selected by user selection, and/or by selection of a distribution of output scores, such as 70% discrepant, and 70% non-discrepant levels or the like.

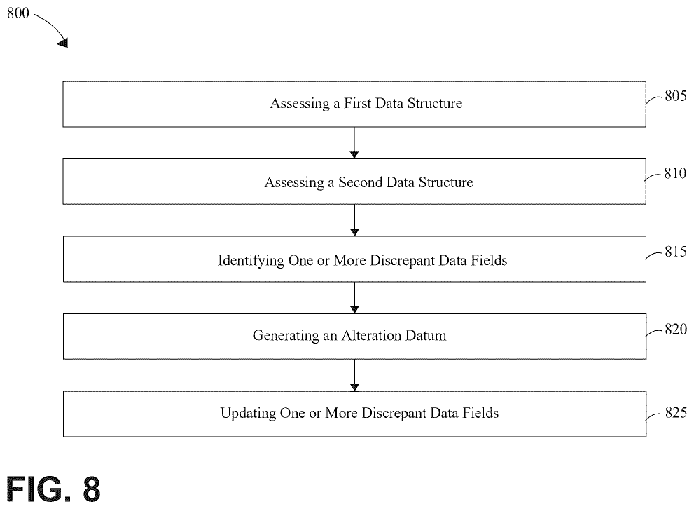

Referring now to FIG. 8, a flow diagram of an exemplary method 800 for resolving data discrepancies between a first data structure and a second data structure is illustrated. Method 800 contains a step 805 of accessing, using at least a processor, a first data structure, wherein the first data structure includes a plurality of first data fields representing primary data, wherein the primary data includes document data. These may be implemented as reference to FIGS. 1-7.

With continued reference to FIG. 8, method 800 contains a step 810 of accessing, using at least a processor, a second data structure, wherein the second data structure includes a plurality of second data fields representing secondary data. In some embodiments, the secondary data may include an output of a requirement machine-learning model, wherein the requirement machine-learning model is configured to generate the secondary data. In some embodiments, the secondary data may include a third party input. These may be implemented as reference to FIGS. 1-7.

With continued reference to FIG. 8, method 800 contains a step 815 of identifying, using at least a processor, one or more discrepant data fields in a plurality of first data fields by comparing a first data structure to a second data structure, wherein identifying the one or more discrepant data fields includes determining a corresponding data field from a plurality of second data fields as a function of primary data and the one or more discrepant data fields is identified when a first data field of the plurality of first data fields does not match the corresponding data field of the plurality of second data fields. These may be implemented as reference to FIGS. 1-7.

With continued reference to FIG. 8, method 800 contains a step 820 of generating, using at least a processor, an alteration datum as a function of one or more discrepant data fields and secondary data in a corresponding data field. In some embodiments, generating the alteration datum may include determining a correction method datum as a function of the one or more discrepant data fields, wherein determining the correction method datum may include determining whether the one or more discrepant data fields needs user-provided corrections or automatic system-generated corrections and generating the alteration datum as a function of the correction method datum. In some embodiments, generating the alteration datum may include generating a user prompt as a function of the one or more discrepant data fields. In some embodiments, generating the user prompt may include generating language training data, wherein the language training data may include exemplary discrepancy data fields correlated to exemplary user prompts, training a large language model using the language training data and generating the user prompt using the trained large language model. In some embodiments, generating the user prompt may include transmitting the user prompt to a user device, receiving a user input from the user device as a function of the user prompt and generating the alteration datum as a function of the user input. In some embodiments, generating the alteration datum may include categorizing the one or more discrepant data fields based on its severity, wherein a discrepant data field with a high severity may trigger generation of a user prompt, wherein the user prompt may include a notification. In some embodiments, generating the alteration datum may include generating alteration training data, wherein the alteration training data may include exemplary discrepant data fields correlated to exemplary alteration data, training an alteration machine-learning model using the alteration training data and generating the alteration datum using the trained alteration machine-learning model. These may be implemented as reference to FIGS. 1-7.

With continued reference to FIG. 8, method 800 contains a step 825 of updating, using at least a processor, one or more discrepant data fields of a plurality of first data fields in a first data structure as a function of an alteration datum, wherein the alteration datum modifies document data of the one or more discrepant data fields to conform with secondary data of a corresponding data field. In some embodiments, updating the one or more discrepant data fields may include reverting the one or more updated discrepant data fields to a previous state if the one or more updated discrepant data fields does not comply with the corresponding data field. These may be implemented as reference to FIGS. 1-7.

It is to be noted that any one or more of the aspects and embodiments described herein may be conveniently implemented using one or more machines (e.g., one or more computing devices that are utilized as a user computing device for an electronic document, one or more server devices, such as a document server, etc.) programmed according to the teachings of the present specification, as will be apparent to those of ordinary skill in the computer art. Appropriate software coding can readily be prepared by skilled programmers based on the teachings of the present disclosure, as will be apparent to those of ordinary skill in the software art. Aspects and implementations discussed above employing software and/or software modules may also include appropriate hardware for assisting in the implementation of the machine executable instructions of the software and/or software module.

Such software may be a computer program product that employs a machine-readable storage medium. A machine-readable storage medium may be any medium that is capable of storing and/or encoding a sequence of instructions for execution by a machine (e.g., a computing device) and that causes the machine to perform any one of the methodologies and/or embodiments described herein. Examples of a machine-readable storage medium include, but are not limited to, a magnetic disk, an optical disc (e.g., CD, CD-R, DVD, DVD-R, etc.), a magneto-optical disk, a read-only memory “ROM” device, a random access memory “RAM” device, a magnetic card, an optical card, a solid-state memory device, an EPROM, an EEPROM, and any combinations thereof. A machine-readable medium, as used herein, is intended to include a single medium as well as a collection of physically separate media, such as, for example, a collection of compact discs or one or more hard disk drives in combination with a computer memory. As used herein, a machine-readable storage medium does not include transitory forms of signal transmission.

Such software may also include information (e.g., data) carried as a data signal on a data carrier, such as a carrier wave. For example, machine-executable information may be included as a data-carrying signal embodied in a data carrier in which the signal encodes a sequence of instruction, or portion thereof, for execution by a machine (e.g., a computing device) and any related information (e.g., data structures and data) that causes the machine to perform any one of the methodologies and/or embodiments described herein.

Examples of a computing device include, but are not limited to, an electronic book reading device, a computer workstation, a terminal computer, a server computer, a handheld device (e.g., a tablet computer, a smartphone, etc.), a web appliance, a network router, a network switch, a network bridge, any machine capable of executing a sequence of instructions that specify an action to be taken by that machine, and any combinations thereof. In one example, a computing device may include and/or be included in a kiosk.

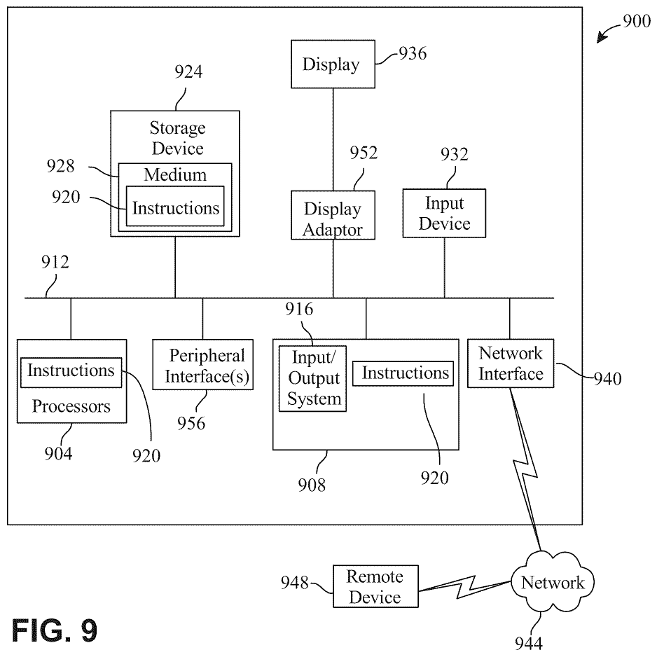

FIG. 9 shows a diagrammatic representation of one embodiment of a computing device in the exemplary form of a computer system 900 within which a set of instructions for causing a control system to perform any one or more of the aspects and/or methodologies of the present disclosure may be executed. It is also contemplated that multiple computing devices may be utilized to implement a specially configured set of instructions for causing one or more of the devices to perform any one or more of the aspects and/or methodologies of the present disclosure. Computer system 900 includes a processor 904 and memory 908 that communicate with each other, and with other components, via a bus 912. Bus 912 may include any of several types of bus structures including, but not limited to, memory bus, memory controller, a peripheral bus, a local bus, and any combinations thereof, using any of a variety of bus architectures.

Processor 904 may include any suitable processor, such as without limitation a processor incorporating logical circuitry for performing arithmetic and logical operations, such as an arithmetic and logic unit (ALU), which may be regulated with a state machine and directed by operational inputs from memory and/or sensors; processor 904 may be organized according to Von Neumann and/or Harvard architecture as a non-limiting example. Processor 904 may include, incorporate, and/or be incorporated in, without limitation, a microcontroller, microprocessor, digital signal processor (DSP), Field Programmable Gate Array (FPGA), Complex Programmable Logic Device (CPLD), Graphical Processing Unit (GPU), general purpose GPU, Tensor Processing Unit (TPU), analog or mixed signal processor, Trusted Platform Module (TPM), a floating point unit (FPU), and/or system on a chip (SoC).

Memory 908 may include various components (e.g., machine-readable media) including, but not limited to, a random-access memory component, a read only component, and any combinations thereof. In one example, a basic input/output system 916 (BIOS), including basic routines that help to transfer information between elements within computer system 900, such as during start-up, may be stored in memory 908. Memory 908 may also include (e.g., stored on one or more machine-readable media) instructions (e.g., software) 920 embodying any one or more of the aspects and/or methodologies of the present disclosure. In another example, memory 908 may further include any number of program modules including, but not limited to, an operating system, one or more application programs, other program modules, program data, and any combinations thereof.

Computer system 900 may also include a storage device 924. Examples of a storage device (e.g., storage device 924) include, but are not limited to, a hard disk drive, a magnetic disk drive, an optical disc drive in combination with an optical medium, a solid-state memory device, and any combinations thereof. Storage device 924 may be connected to bus 912 by an appropriate interface (not shown). Example interfaces include, but are not limited to, SCSI, advanced technology attachment (ATA), serial ATA, universal serial bus (USB), IEEE 1394 (FIREWIRE), and any combinations thereof. In one example, storage device 924 (or one or more components thereof) may be removably interfaced with computer system 900 (e.g., via an external port connector (not shown)). Particularly, storage device 924 and an associated machine-readable medium 928 may provide nonvolatile and/or volatile storage of machine-readable instructions, data structures, program modules, and/or other data for computer system 900. In one example, software 920 may reside, completely or partially, within machine-readable medium 928. In another example, software 920 may reside, completely or partially, within processor 904.

Computer system 900 may also include an input device 932. In one example, a user of computer system 900 may enter commands and/or other information into computer system 900 via input device 932. Examples of an input device 932 include, but are not limited to, an alpha-numeric input device (e.g., a keyboard), a pointing device, a joystick, a gamepad, an audio input device (e.g., a microphone, a voice response system, etc.), a cursor control device (e.g., a mouse), a touchpad, an optical scanner, a video capture device (e.g., a still camera, a video camera), a touchscreen, and any combinations thereof. Input device 932 may be interfaced to bus 912 via any of a variety of interfaces (not shown) including, but not limited to, a serial interface, a parallel interface, a game port, a USB interface, a FIREWIRE interface, a direct interface to bus 912, and any combinations thereof. Input device 932 may include a touch screen interface that may be a part of or separate from display 936, discussed further below. Input device 932 may be utilized as a user selection device for selecting one or more graphical representations in a graphical interface as described above.

A user may also input commands and/or other information to computer system 900 via storage device 924 (e.g., a removable disk drive, a flash drive, etc.) and/or network interface device 940. A network interface device, such as network interface device 940, may be utilized for connecting computer system 900 to one or more of a variety of networks, such as network 944, and one or more remote devices 948 connected thereto. Examples of a network interface device include, but are not limited to, a network interface card (e.g., a mobile network interface card, a LAN card), a modem, and any combination thereof. Examples of a network include, but are not limited to, a wide area network (e.g., the Internet, an enterprise network), a local area network (e.g., a network associated with an office, a building, a campus or other relatively small geographic space), a telephone network, a data network associated with a telephone/voice provider (e.g., a mobile communications provider data and/or voice network), a direct connection between two computing devices, and any combinations thereof. A network, such as network 944, may employ a wired and/or a wireless mode of communication. In general, any network topology may be used. Information (e.g., data, software 920, etc.) may be communicated to and/or from computer system 900 via network interface device 940.

Computer system 900 may further include a video display adapter 952 for communicating a displayable image to a display device, such as display 936. Examples of a display device include, but are not limited to, a liquid crystal display (LCD), a cathode ray tube (CRT), a plasma display, a light emitting diode (LED) display, and any combinations thereof. Display adapter 952 and display 936 may be utilized in combination with processor 904 to provide graphical representations of aspects of the present disclosure. In addition to a display device, computer system 900 may include one or more other peripheral output devices including, but not limited to, an audio speaker, a printer, and any combinations thereof. Such peripheral output devices may be connected to bus 912 via a peripheral interface 956. Examples of a peripheral interface include, but are not limited to, a serial port, a USB connection, a FIREWIRE connection, a parallel connection, and any combinations thereof.

The foregoing has been a detailed description of illustrative embodiments of the invention. Various modifications and additions can be made without departing from the spirit and scope of this invention. Features of each of the various embodiments described above may be combined with features of other described embodiments as appropriate in order to provide a multiplicity of feature combinations in associated new embodiments. Furthermore, while the foregoing describes a number of separate embodiments, what has been described herein is merely illustrative of the application of the principles of the present invention. Additionally, although particular methods herein may be illustrated and/or described as being performed in a specific order, the ordering is highly variable within ordinary skill to achieve methods and apparatuses according to the present disclosure. Accordingly, this description is meant to be taken only by way of example, and not to otherwise limit the scope of this invention.

Exemplary embodiments have been disclosed above and illustrated in the accompanying drawings. It will be understood by those skilled in the art that various changes, omissions and additions may be made to that which is specifically disclosed herein without departing from the spirit and scope of the present invention.

1. An apparatus for resolving data discrepancies between a first data structure and a second data structure, the apparatus comprising:
at least a processor;
a memory communicatively connected to the at least a processor, wherein the memory contains instructions configuring the at least a processor to:
access a first data structure, wherein the first data structure comprises a plurality of first data fields representing primary data, wherein the primary data comprises document data;
access a second data structure, wherein the second data structure comprises a plurality of second data fields representing secondary data;
analyze, using a language processing module, the document data of the primary data representing the plurality of first data fields by:
extracting textual data from the document data by extracting one or more words represented by strings of one or more characters;
parsing the strings of the textual data into at least a token including sequences of characters; and
detecting associations between the one or more words extracted from the document data; and
an encoder component comprising a transformer architecture configured to use:
a self-attention mechanism for detecting the associations between the one or more words extracted from the document data; and
a positional encoding mechanism for encoding a position of an extracted word in a sequence of the textual data,
wherein the encoder component is configured to identify one or more discrepant data fields in the plurality of first data fields by comparing the first data structure, including the document data analyzed by the language processing module, to the second data structure, wherein:
identifying the one or more discrepant data fields comprises automatically mapping a first data field of the first data structure to a corresponding data field from the plurality of second data fields as a function of the primary data by:
transforming at least the textual data of the document data analyzed by the language processing module into a vector format;
dynamically determining and assigning weights, using an attention mechanism of the encoder component, to different vectorized tokens of the at least a token of the parsed textual data;
comparing the weighted vectorized tokens of the primary data to the secondary data using a similarity function operating on attention-weighted vector representations to compute a correspondence score between the mapped first data field and the corresponding data field; and
identifying the one or more discrepant data fields when the correspondence score fails to satisfy a similarity criterion; and
the one or more discrepant data fields is identified when the mapped first data field of the plurality of first data fields does not match the corresponding mapped data field of the plurality of second data fields;
generate an alteration datum as a function of the one or more discrepant data fields and the secondary data in the corresponding data field; and
update the one or more discrepant data fields of the plurality of first data fields in the first data structure as a function of the alteration datum, wherein the alteration datum modifies the document data of the one or more discrepant data fields to conform with the secondary data of the corresponding data field.

2. The apparatus of claim 1, wherein the secondary data comprises an output of a requirement machine-learning model, wherein the requirement machine-learning model is configured to generate the secondary data.

3. The apparatus of claim 1, wherein the secondary data comprises a third party input.

4. The apparatus of claim 1, wherein generating the alteration datum comprises:
determining a correction method datum as a function of the one or more discrepant data fields, wherein determining the correction method datum comprises determining whether the one or more discrepant data fields needs user-provided corrections or automatic system-generated corrections; and
generating the alteration datum as a function of the correction method datum.

5. The apparatus of claim 1, wherein generating the alteration datum comprises generating a user prompt as a function of the one or more discrepant data fields.

6. The apparatus of claim 5, wherein generating the user prompt comprises:
generating language training data, wherein the language training data comprises exemplary discrepancy data fields correlated to exemplary user prompts;
training a large language model using the language training data; and
generating the user prompt using the trained large language model.

7. The apparatus of claim 5, wherein generating the user prompt comprises:
transmitting the user prompt to a user device;
receiving a user input from the user device as a function of the user prompt; and
generating the alteration datum as a function of the user input.

8. The apparatus of claim 1, wherein generating the alteration datum comprises categorizing the one or more discrepant data fields based on its severity, wherein a discrepant data field with a high severity triggers generation of a user prompt, wherein the user prompt comprises a notification.

9. The apparatus of claim 1, wherein generating the alteration datum comprises:
generating alteration training data, wherein the alteration training data comprises exemplary discrepant data fields correlated to exemplary alteration data;
training an alteration machine-learning model using the alteration training data; and
generating the alteration datum using the trained alteration machine-learning model.

10. The apparatus of claim 1, further comprising reverting the one or more updated discrepant data fields to a previous state if the one or more updated discrepant data fields does not comply with the corresponding data field.

11. A method for resolving data discrepancies between a first data structure and a second data structure, the method comprising:
accessing, using at least a processor, a first data structure, wherein the first data structure comprises a plurality of first data fields representing primary data, wherein the primary data comprises document data;
accessing, using the at least a processor, a second data structure, wherein the second data structure comprises a plurality of second data fields representing secondary data;
analyzing, using the at least a processor and a language processing module, the document data of the primary data representing the plurality of first data fields by:
extracting textual data from the document data by extracting one or more words represented by strings of one or more characters;
parsing the strings of the textual data into at least a token including sequences of characters; and
detecting, by a self-attention mechanism of an encoder component, associations between the one or more words extracted from the document data;
encoding, by a positional encoding mechanism, a position of an extracted word in a sequence of the textual data;
identifying, using the at least a processor and the encoder, one or more discrepant data fields in the plurality of first data fields by comparing the first data structure, including the document data analyzed by the language processing module, to the second data structure, wherein:
identifying the one or more discrepant data fields comprises automatically mapping a first data field of the first data structure to a corresponding data field from the plurality of second data fields as a function of the primary data by:
transforming at least the textual data of the document data analyzed by the language processing module into a vector format;
dynamically determining and assigning weights, by an attention mechanism of the encoder, to different vectorized tokens of the at least a token of the parsed textual data;
comparing the weighted vectorized tokens of the primary data to the secondary data using a similarity function operating on attention-weighted vector representations to compute a correspondence score between the mapped first data field and the corresponding data field; and
identifying the one or more discrepant data fields when the correspondence score fails to satisfy a similarity criterion; and
the one or more discrepant data fields is identified when the mapped first data field of the plurality of first data fields does not match the corresponding mapped data field of the plurality of second data fields;
generating, using the at least a processor, an alteration datum as a function of the one or more discrepant data fields and the secondary data in the corresponding data field; and
updating, using the at least a processor, the one or more discrepant data fields of the plurality of first data fields in the first data structure as a function of the alteration datum, wherein the alteration datum modifies the document data of the one or more discrepant data fields to conform with the secondary data of the corresponding data field.

12. The method of claim 11, wherein the secondary data comprises an output of a requirement machine-learning model, wherein the requirement machine-learning model is configured to generate the secondary data.

13. The method of claim 11, wherein the secondary data comprises a third party input.

14. The method of claim 11, wherein generating the alteration datum comprises:
determining a correction method datum as a function of the one or more discrepant data fields, wherein determining the correction method datum comprises determining whether the one or more discrepant data fields needs user-provided corrections or automatic system-generated corrections; and
generating the alteration datum as a function of the correction method datum.

15. The method of claim 11, wherein generating the alteration datum comprises generating a user prompt as a function of the one or more discrepant data fields.

16. The method of claim 15, wherein generating the user prompt comprises:
generating language training data, wherein the language training data comprises exemplary discrepancy data fields correlated to exemplary user prompts;
training a large language model using the language training data; and
generating the user prompt using the trained large language model.

17. The method of claim 15, wherein generating the user prompt comprises:
transmitting the user prompt to a user device;
receiving a user input from the user device as a function of the user prompt; and
generating the alteration datum as a function of the user input.

18. The method of claim 11, wherein generating the alteration datum comprises categorizing the one or more discrepant data fields based on its severity, wherein a discrepant data field with a high severity triggers generation of a user prompt, wherein the user prompt comprises a notification.

19. The method of claim 11, wherein generating the alteration datum comprises:
generating alteration training data, wherein the alteration training data comprises exemplary discrepant data fields correlated to exemplary alteration data;
training an alteration machine-learning model using the alteration training data; and
generating the alteration datum using the trained alteration machine-learning model.

20. The method of claim 11, further comprising reverting the one or more updated discrepant data fields to a previous state if the one or more updated discrepant data fields does not comply with the corresponding data field.
